(19) United States
(12) Patent Application Publication
(10) Pub. No.: US 2026/0089733 A1
(43) Pub. Date: Mar. 26, 2026

(54) BROADCAST AND MULTICAST DOWNLINK CONTROL INFORMATION VIA PHYSICAL DOWNLINK SHARED CHANNEL

(71) Applicant: QUALCOMM Incorporated, San Diego, CA (US)

(72) Inventors: Morteza SOLTANI, San Diego, CA (US); Jing SUN, San Diego, CA (US); Jing JIANG, San Diego, CA (US)

(21) Appl. No.: 18/893,753

(22) Filed: Sep. 23, 2024

(51) Int. Cl. H04W 72/232; H04L 27/26; H04W 72/30

(52) U.S. Cl. CPC H04W 72/232; H04L 27/2669; H04W 72/30

(57) ABSTRACT

Methods, systems, and devices for wireless communications are described. Downlink control information (DCI) may be used for multiple purposes such as scheduling uplink data, scheduling downlink data, or adjusting transmission power. DCI may be delivered via a physical downlink control channel (PDCCH). Some of the control information conveyed by DCI may be offloaded to a physical downlink shared channel (PDSCH). In a broadcast or multicast PDSCH conveying multiple DCI components for multiple user equipments (UEs), the network may group DCI components for UEs having a same target code rate into groups (e.g., transport blocks), and may encode those groups of DCI using modulation and coding schemes (MCSs) to achieve the target code rates. The DCI conveyed on a PDCCH may schedule the broadcast or multicast PDSCH conveying the multiple DCI components for the multiple UEs.

### INTRODUCTION

The following relates to wireless communications that pertain to broadcast and multicast two-stage downlink control information via a physical downlink shared channel.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method of wireless communication performed by a first network entity is described. The method may include receiving first downlink control information (DCI) via a downlink control channel transmission, where the first DCI indicates first scheduling information for a downlink shared channel transmission, and where the first DCI indicates that the downlink shared channel transmission is scheduled to convey a set of multiple second DCI components, receiving the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective modulation and coding scheme (MCS), and decoding a particular DCI component of the set of multiple DCI components.

A first network entity for wireless communications is described. The first network entity may include a processing system configured to: receive first DCI via a downlink control channel transmission, where the first DCI indicates first scheduling information for a downlink shared channel transmission, and where the first DCI indicates that the downlink shared channel transmission is scheduled to convey a set of multiple second DCI components, receive the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective MCS, and decode a particular DCI component of the set of multiple DCI components.

Another first network entity for wireless communications is described. The first network entity may include means for receiving first DCI via a downlink control channel transmission, where the first DCI indicates first scheduling information for a downlink shared channel transmission, and where the first DCI indicates that the downlink shared channel transmission is scheduled to convey a set of multiple second DCI components, means for receiving the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective MCS, and means for decoding a particular DCI component of the set of multiple DCI components.

A non-transitory computer-readable medium storing code for wireless communications is described. The code may include instructions executable by one or more processors to receive first DCI via a downlink control channel transmission, where the first DCI indicates first scheduling information for a downlink shared channel transmission, and where the first DCI indicates that the downlink shared channel transmission is scheduled to convey a set of multiple second DCI components, receive the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective MCS, and decode a particular DCI component of the set of multiple DCI components.

In some examples of the method, first network entities, and non-transitory computer-readable medium described herein, the set of multiple groups includes a first group and a second group, the first group includes a first subset of DCI components of the set of multiple DCI components, and the second group includes a second subset of DCI components of the set of multiple DCI components.

In some examples of the method, first network entities, and non-transitory computer-readable medium described herein, the first subset of DCI components includes a first DCI component and a second DCI component, the second subset of DCI components includes a third DCI component, the first DCI component and the second DCI component may be encoded with a first MCS, and the third DCI component may be encoded with a second MCS different than the first MCS.

In some examples of the method, first network entities, and non-transitory computer-readable medium described herein, the second subset of DCI components includes a fourth DCI component and the fourth DCI component may be encoded with the second MCS.

In some examples of the method, first network entities, and non-transitory computer-readable medium described herein, decoding the particular DCI component may include operations, features, means, or instructions for determining that a particular group includes a first cyclic redundancy check (CRC) scrambled by a group identifier, where the particular group includes the particular DCI component and determining that the particular DCI component includes a second CRC scrambled by a device identifier associated with the first network entity.

Some examples of the method, first network entities, and non-transitory computer-readable medium described herein may further include operations, features, means, or instructions for receive information indicative of the group identifier and the device identifier, where the group identifier and the device identifier may be associated with the first network entity.

In some examples of the method, first network entities, and non-transitory computer-readable medium described herein, a particular group that includes the particular DCI component including a first CRC scrambled by a group identifier, where the particular group includes the particular DCI component; and the particular DCI component including a second CRC scrambled by a device identifier associated with the first network entity.

Some examples of the method, first network entities, and non-transitory computer-readable medium described herein may further include operations, features, means, or instructions for performing a subsequent shared channel transmission in accordance with the particular DCI component, where the particular DCI component schedules the subsequent shared channel transmission.

In some examples of the method, first network entities, and non-transitory computer-readable medium described herein, a quantity of groups of the set of multiple groups; a time domain resource allocation (TDRA) of the downlink shared channel transmission; a frequency domain resource allocation (FDRA) of the downlink shared channel transmission; a rank of the downlink shared channel transmission; a respective payload size of each DCI component of the set of multiple DCI components; a respective code rate for each respective group of the set of multiple groups; or a demodulation reference signal (DMRS) configuration for the downlink shared channel transmission.

In some examples of the method, first network entities, and non-transitory computer-readable medium described herein, the first DCI includes an indication of a modulation order of the set of multiple groups.

Some examples of the method, first network entities, and non-transitory computer-readable medium described herein may further include operations, features, means, or instructions for receiving an indication of a group identifier associated with the set of multiple network entities, where the downlink shared channel transmission includes a single DMRS associated with the set of multiple groups, where the single DMRS may be scrambled by the group identifier.

In some examples of the method, first network entities, and non-transitory computer-readable medium described herein, at least a portion of the first scheduling information may be conveyed via one or more repurposed hybrid automatic repeat request fields of the first DCI.

In some examples of the method, first network entities, and non-transitory computer-readable medium described herein, the downlink shared channel transmission includes a header associated with the set of multiple groups.

In some examples of the method, first network entities, and non-transitory computer-readable medium described herein, a quantity of groups of the set of multiple groups; a respective payload size of each DCI component of the set of multiple DCI components; a respective code rate for each respective group of the set of multiple groups; a DMRS configuration for the downlink shared channel transmission; a respective TDRA for each group of the set of multiple groups; or a respective FDRA for each group of the set of multiple groups.

In some examples of the method, first network entities, and non-transitory computer-readable medium described herein, the first DCI includes header information associated with the header.

In some examples of the method, first network entities, and non-transitory computer-readable medium described herein, a code rate for the header; a TDRA for the header; an FDRA for the header; or a DMRS configuration for the header.

Some examples of the method, first network entities, and non-transitory computer-readable medium described herein may further include operations, features, means, or instructions for receiving an indication of a group identifier associated with the set of multiple network entities where the header includes a CRC scrambled by the group identifier.

Some examples of the method, first network entities, and non-transitory computer-readable medium described herein may further include operations, features, means, or instructions for receiving, via the downlink shared channel transmission, a single DMRS associated with the set of multiple groups and the header.

In some examples of the method, first network entities, and non-transitory computer-readable medium described herein, the downlink shared channel transmission may be a broadcast DCI only physical downlink shared channel (PDSCH) transmission or a multicast DCI only PDSCH transmission.

In some examples of the method, first network entities, and non-transitory computer-readable medium described herein, the downlink shared channel transmission may be a PDSCH transmission.

In some examples of the method, first network entities, and non-transitory computer-readable medium described herein, respective DCI components of each group of the set of multiple groups may be encoded as a respective transport block via the different respective MCS.

A method of wireless communications performed by a first network entity is described. The method may include outputting to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components each associated with and outputting, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of a set of multiple second network entities, and a respective group of the set of multiple groups, where each group of the set of multiple groups is associated with a different respective MCS.

A first network entity for wireless communications is described. The first network entity may include a processing system configured to: output to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components each associated with and output, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of a set of multiple second network entities, and a respective group of the set of multiple groups, where each group of the set of multiple groups is associated with a different respective MCS.

Another first network entity for wireless communications is described. The first network entity may include means for outputting to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components each associated with and means for outputting, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of a set of multiple second network entities, and a respective group of the set of multiple groups, where each group of the set of multiple groups is associated with a different respective MCS.

A non-transitory computer-readable medium having code for wireless communications is described. The code, when executed by a first network entity, may cause the first network entity to: output to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components each associated with and output, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of a set of multiple second network entities, and a respective group of the set of multiple groups, where each group of the set of multiple groups is associated with a different respective MCS.

In some examples of the method, first network entities, and non-transitory computer-readable medium described herein, the set of multiple groups includes a first group and a second group, the first group includes a first subset of DCI components of the set of multiple DCI components, and the second group includes a second subset of DCI components of the set of multiple DCI components.

In some examples of the method, first network entities, and non-transitory computer-readable medium described herein, the first subset of DCI components includes a first DCI component and a second DCI component, the second subset of DCI components includes a third DCI component, the first DCI component and the second DCI component may be encoded with a first MCS, and the third DCI component may be encoded with a second MCS different than the first MCS.

In some examples of the method, first network entities, and non-transitory computer-readable medium described herein, the second subset of DCI components includes a fourth DCI component and the fourth DCI component may be encoded with the second MCS.

In some examples of the method, first network entities, and non-transitory computer-readable medium described herein, a particular group includes a first CRC scrambled by a group identifier associated with the particular group and a particular DCI component within the particular group includes a second CRC scrambled by a device identifier associated with a particular respective second network entity of the set of multiple second network entities.

Some examples of the method, second network entities, and non-transitory computer-readable medium described herein may further include operations, features, means, or instructions for outputting, to the particular respective second network entity, information indicative of the group identifier and the device identifier, where the group identifier and the device identifier may be associated with the particular respective second network entity.

Some examples of the method, second network entities, and non-transitory computer-readable medium described herein may further include operations, features, means, or instructions for performing a subsequent shared channel transmission in accordance with a particular DCI component of the set of multiple DCI components, where the particular DCI component schedules the subsequent shared channel transmission.

In some examples of the method, first network entities, and non-transitory computer-readable medium described herein, a quantity of groups of the set of multiple groups; a TDRA of the downlink shared channel transmission; an FDRA of the downlink shared channel transmission; a rank of the downlink shared channel transmission; a respective payload size of each DCI component of the set of multiple DCI components; a respective code rate for each respective group of the set of multiple groups; or a DMRS configuration for the downlink shared channel transmission.

In some examples of the method, first network entities, and non-transitory computer-readable medium described herein, the first DCI includes an indication of a modulation order of the set of multiple groups.

Some examples of the method, second network entities, and non-transitory computer-readable medium described herein may further include operations, features, means, or instructions for outputting an indication of a group identifier associated with the set of multiple second network entities, where the downlink shared channel transmission includes a single DMRS associated with the set of multiple groups, where the single DMRS may be scrambled by the group identifier.

In some examples of the method, first network entities, and non-transitory computer-readable medium described herein, at least a portion of the first scheduling information may be conveyed via one or more repurposed hybrid automatic repeat request fields of the first DCI.

In some examples of the method, first network entities, and non-transitory computer-readable medium described herein, the downlink shared channel transmission includes a header associated with the set of multiple groups.

In some examples of the method, first network entities, and non-transitory computer-readable medium described herein, a quantity of groups of the set of multiple groups; a respective payload size of each DCI component of the set of multiple DCI components; a respective code rate for each respective group of the set of multiple groups; a DMRS configuration for the downlink shared channel transmission; a respective TDRA for each group of the set of multiple groups; or a respective FDRA for each group of the set of multiple groups.

In some examples of the method, first network entities, and non-transitory computer-readable medium described herein, the first DCI includes header information associated with the header.

In some examples of the method, first network entities, and non-transitory computer-readable medium described herein, a code rate for the header; a TDRA for the header; an FDRA for the header; or a DMRS configuration for the header.

Some examples of the method, second network entities, and non-transitory computer-readable medium described herein may further include operations, features, means, or instructions for outputting an indication of a group identifier associated with the set of multiple second network entities, where the header includes a CRC scrambled by the group identifier.

Some examples of the method, second network entities, and non-transitory computer-readable medium described herein may further include operations, features, means, or instructions for outputting, via the downlink shared channel transmission, a single DMRS associated with the set of multiple groups and the header.

In some examples of the method, first network entities, and non-transitory computer-readable medium described herein, the downlink shared channel transmission may be a broadcast DCI only PDSCH transmission or a multicast DCI only PDSCH transmission.

In some examples of the method, first network entities, and non-transitory computer-readable medium described herein, the downlink shared channel transmission may be a PDSCH transmission.

In some examples of the method, first network entities, and non-transitory computer-readable medium described herein, respective DCI components of each group of the set of multiple groups may be encoded as a respective transport block via the different respective MCS.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports broadcast and multicast downlink control information (DCI) via a physical downlink shared channel (PDSCH) in accordance with one or more aspects of the present disclosure.

FIG. 2 shows examples of resource diagrams that support broadcast and multicast DCI via PDSCH in accordance with one or more aspects of the present disclosure.

FIG. 3 shows an example of a wireless communications system that supports broadcast and multicast DCI via PDSCH in accordance with one or more aspects of the present disclosure.

FIG. 4 shows examples of two-part DCI diagrams that supports broadcast and multicast DCI via PDSCH in accordance with one or more aspects of the present disclosure.

FIG. 5 shows an example of a process flow that supports broadcast and multicast DCI via PDSCH in accordance with one or more aspects of the present disclosure.

FIGS. 6 and 7 show block diagrams of devices that support broadcast and multicast DCI via PDSCH in accordance with one or more aspects of the present disclosure.

FIG. 8 shows a block diagram of a communications manager that supports broadcast and multicast DCI via PDSCH in accordance with one or more aspects of the present disclosure.

FIG. 9 shows a diagram of a system including a device that supports broadcast and multicast DCI via PDSCH in accordance with one or more aspects of the present disclosure.

FIGS. 10 and 11 show block diagrams of devices that support broadcast and multicast DCI via PDSCH in accordance with one or more aspects of the present disclosure.

FIG. 12 shows a block diagram of a communications manager that supports broadcast and multicast DCI via PDSCH in accordance with one or more aspects of the present disclosure.

FIG. 13 shows a diagram of a system including a device that supports broadcast and multicast DCI via PDSCH in accordance with one or more aspects of the present disclosure.

FIGS. 14 and 15 show flowcharts illustrating methods that support broadcast and multicast DCI via PDSCH in accordance with one or more aspects of the present disclosure.

### DETAILED DESCRIPTION

In wireless communications systems, downlink control information (DCI) may be used for multiple purposes such as scheduling uplink data, scheduling downlink data, or adjusting transmission power. DCI may be delivered via a physical downlink control channel (PDCCH). A user equipment (UE) may perform blind decoding on multiple decoding candidates (e.g., search spaces (SSs)) associated with a configured control resource set (CORESET) to identify DCI that targets the UE. For example, a CORESET and one or more SSs may be configured for a UE in radio resource control (RRC) signaling. Blind decoding may be designed to accommodate multiple UEs receiving PDCCH from a same network entity (e.g., within a same cell at a same time). For example, blind decoding may reduce blocking between UEs to randomly hash locations of PDCCH for different UEs differently in a same CORESET. Blind decoding may involve a high processing burden at the UE.

In some cases, some of the control information conveyed by DCI may be offloaded to a physical downlink shared channel (PDSCH), which may reduce the size of DCI conveyed via a PDCCH to reduce the amount of blind decoding at the UE (e.g., as the UE blindly decodes PDCCH candidates). For example, the variable length part of DCI may be piggybacked onto a PDSCH, and multiple DCI components may accordingly be broadcast or multicast on a PDCCH and on a corresponding PDSCH that is scheduled by the PDCCH. In some cases, the multiple DCI components for the multiple UEs may have the same length on the PDCCH. The variable portions of the DCIs for the given UEs may be conveyed on a broadcast or multicast PDSCH.

Based on a position of a UE within a cell, the network may adjust the code rate used to communicate with the UE. For example, the network may use a more aggressive code rate for cell-centered UEs than for cell-edge UEs. The code rate may be controlled by the modulation and coding scheme (MCS) used for a shared channel transmission (e.g., a PDSCH). Accordingly, the different UEs addressed in a broadcast or multicast PDSCH may have different target code rates.

In a broadcast or multicast PDSCH that conveys multiple DCI components for multiple UEs, the network may group DCI components for UEs having a same target code rate into groups (e.g., transport blocks), and may encode those groups of DCI components (e.g., which may be grouped into transport blocks) using MCSs to achieve the target code rates. The network may assign group radio network temporary identifiers (RNTIs) to UEs within the group of DCI components. Accordingly, a particular UE may identify which group or transport block of multiple groups or transport blocks within a PDSCH conveys the DCI component for that particular UE based on the group or transport block having a cyclic redundancy check (CRC) scrambled by the group RNTI assigned to the particular UE. The particular UE may identify the DCI component within a group or transport block that is targeted for the particular UE based on the DCI component having a CRC scrambled by the RNTI for the particular UE. The DCI conveyed on the PDCCH may schedule the broadcast or multicast PDSCH conveying the multiple DCI components. In some aspects, the PDCCH may include information about the PDSCH, such as the quantity of groups or transport blocks, the time domain resource allocation (TDRA) for the PDSCH, the frequency domain resource allocation (FDRA) for the PDSCH, the rank of the PDSCH, the payload size of the DCI components, the code rate of the groups or transport blocks, the MCS of the groups or transport blocks, and/or the demodulation reference signal (DMRS) configuration for the PDSCH. In some aspects, the multiple groups or transport blocks may share a single DMRS, thereby reducing overhead.

Aspects of the disclosure are initially described in the context of wireless communications systems. Aspects of the disclosure are further illustrated by and described with reference to resource diagrams, two-part DCI diagrams, apparatus diagrams, system diagrams, and flowcharts that relate to broadcast and multicast DCI via PDSCH.

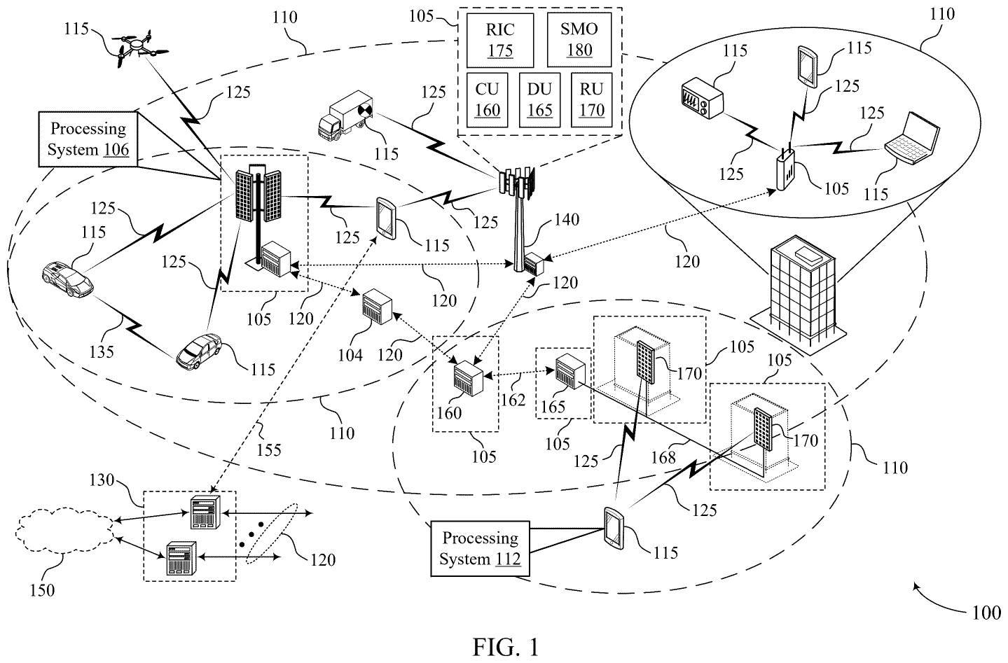

FIG. 1 shows an example of a wireless communications system 100 that supports broadcast and multicast DCI via PDSCH in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network illustrated in the wireless communications system 100. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some aspects, the first communication interface may be an interface configured to receive input information, and the information may be provided to the processing system. In some aspects, the second system interface may be configured to transmit information output from the chip or modem. The second communication interface may also obtain or receive input information, and the first communication interface may also output, transmit, or provide information.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support broadcast and multicast DCI via PDSCH as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some aspects, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, In some aspects, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other aspects.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some aspects, the beam direction associated with transmissions along a single beam direction may be determined based on a signal that was transmitted along one or more beam directions.

For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a CRC), forward error correction (FEC), and retransmission (e.g., automatic repeat request (ARQ)). HARQ may improve throughput at the MAC layer in relatively poor radio conditions (e.g., low signal-to-noise conditions). In some aspects, a device may support same-slot HARQ feedback, in which case the device may provide HARQ feedback in a specific slot for data received via a previous symbol in the slot. In some other aspects, the device may provide HARQ feedback in a subsequent slot, or according to some other time interval.

A network entity 105 may use DCI for multiple purposes such as scheduling uplink data, scheduling downlink data, or adjusting transmission power. DCI may be delivered via a PDCCH. A UE 115 may perform blind decoding on multiple decoding candidates (e.g., SSs) associated with a configured CORESET to identify DCI that targets the UE 115. For example, a CORESET and one or more SSs may be configured for a UE 115 in RRC signaling. Blind decoding may be designed to accommodate multiple UEs 115 receiving PDCCH from a same network entity 105 (e.g., within a same cell at a same time). For example, blind decoding may reduce blocking between UEs 115 to randomly hash locations of PDCCH for different UEs 115 differently in a same CORESET. Blind decoding may involve a high processing burden at the UE 115. With respect to LTE and NR, NR PDCCH may use beamforming and different resource allocations.

In some cases, some of the control information conveyed by DCI may be offloaded from PDCCH to a PDSCH, which may reduce the size of DCI conveyed by the PDCCH to reduce the amount of blind decoding at the UE 115. For example, the variable length part of DCI may be piggybacked onto a PDSCH, and multiple DCI components may accordingly be broadcast or multicast on a PDSCH. Offloading information conveyed by DCI from a PDCCH to a PDSCH may save PDCCH resources for other UEs 115, such as UEs without downlink grants. In some aspects, offloading information conveyed by DCI from PDCCH to a PDSCH may result in more efficient delivery of control information. For example, offloading information conveyed by DCI from PDCCH to a PDSCH may allow for less bits being used for CRC (e.g., thereby reducing CRC overhead) via enabling aggregation of multiple DCI components for multiple UEs. Additionally, or alternatively, offloading information conveyed by DCI from PDCCH to a PDSCH may allow for CRC length reduction as less pruning may be demanded. Additionally, or alternatively, offloading information conveyed by DCI from PDCCH to a PDSCH may allow for sharing of a DMRS for control and data information conveyed by the PDSCH. Additionally, or alternatively, offloading information conveyed by DCI from PDCCH to a PDSCH may allow for beamforming and rank efficiency, as data rate control may be reused for control information, possibly with a backoff for higher reliability as compared to data, due to the lack of retransmission protocols for control information (e.g., the information conveyed by DCI).

In some aspects, the multiple DCI components for the multiple UEs 115 may have the same length on the PDCCH. The variable portions of the DCI components for the multiple UEs 115 may be conveyed on a broadcast or multicast PDSCH. Based on a position of a UE 115 within a cell, the network entity 105 may adjust the code rate used to communicate with the UE 115. For example, the network may use a more aggressive code rate for cell-centered UEs 115 than for cell-edge UEs 115. The code rate may be controlled by the MCS. Accordingly, the different UEs 115 addressed in a broadcast or multicast PDSCH may have different target code rates.

In a broadcast or multicast PDSCH that conveys multiple DCI components for multiple UEs 115 (e.g., a broadcast or multicast DCI only PDSCH), the network entity 105 may group DCI components for UEs 115 having a same target code rate into groups (e.g., transport blocks), and may encode those groups of DCI components (e.g., which may be grouped into transport blocks) using MCSs to achieve the target code rates. The network entity 105 may assign group RNTIs to UEs 115 within the group of DCI components. Accordingly, a particular UE 115 may identify which group or transport block of multiple groups or transport blocks within a PDSCH conveys the DCI component for that particular UE 115 based on the group or transport block having a CRC scrambled by the group RNTI assigned to the particular UE 115. The particular UE 115 may identify the DCI component within a group or transport block that is targeted for the particular UE 115 based on the DCI component having a CRC scrambled by the RNTI for the particular UE 115. The DCI conveyed on the PDCCH may schedule the broadcast or multicast PDSCH conveying the multiple DCI components. In some aspects, the PDCCH may include information about the PDSCH, such as the quantity of groups or transport blocks, the TDRA for the PDSCH, the FDRA for the PDSCH, the rank of the PDSCH, the payload size of the DCI components, the code rate of the groups or transport blocks, or the DMRS configuration for the PDSCH. In some aspects, the multiple groups or transport blocks may share a single DMRS, thereby reducing overhead.

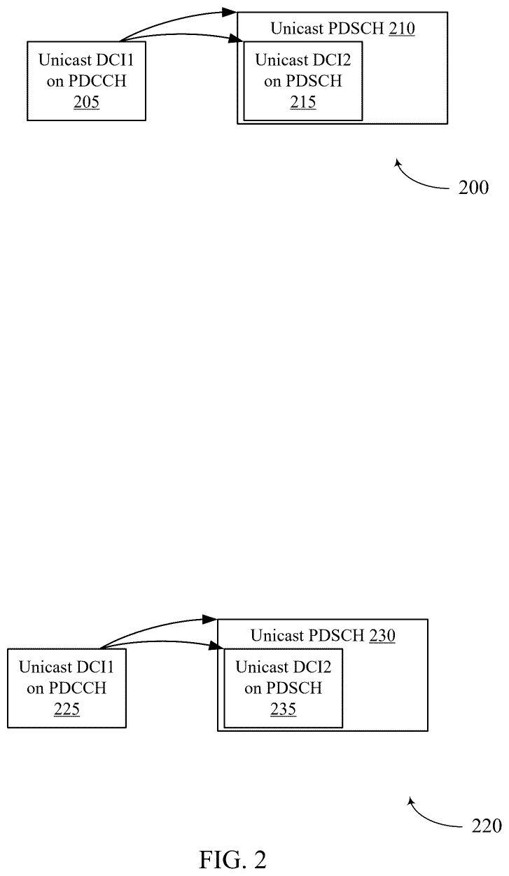

FIG. 2 shows an example of a resource diagram 200 and a resource diagram 220 that support broadcast and multicast DCI via PDSCH in accordance with one or more aspects of the present disclosure. The resource diagram 200 and the resource diagram 220 may implement or may be implemented by aspects of the wireless communications system 100.

As shown in the resource diagram 200, in a unicast mode, UE-specific control information may be transmitted to a UE 115 via DCI 205 and DCI 215. The DCI 205 may be conveyed via a PDCCH, and the UE 115 may blindly decode the DCI 205 on the PDCCH (e.g., the DCI 205 on the PDCCH may be unicast) using the cell RNTI (C-RNTI) for the UE 115. The DCI 205 may include scheduling information for the PDSCH 210, which may be a unicast to the UE 115. The PDCCH that conveys the DCI 205 may be associated with the SS and the CORESET configured for the UE 115 (e.g., in RRC signaling). The PDSCH 210 may include DCI 215, which may include control information (e.g., some of the control information that would otherwise be conveyed in the DCI 205 may be offloaded to the DCI 215). For example, offloaded information may include parameters for the PDSCH 210. As the UE 115 may blindly decode the DCI 205 on the PDCCH using the C-RNTI, a UE identifier field (e.g., a C-RNTI or other RNTI for the UE 115) may not be signaled in the DCI 215.

As shown in the resource diagram 220, in a broadcast or multicast mode, the network entity 105 may address all (e.g., all UEs 115 served by the network entity 105) or a group of UEs 115 using DCI 225 conveyed via a PDCCH. The DCI 225 conveyed via the PDCCH may include scheduling information for the PDSCH 230, which may be a broadcast or multicast PDSCH. The PDSCH 230 may convey DCI 235. The DCI 235 may include UE-specific control information for the different UEs 115 (e.g., for each UE 115 addressed in the PDSCH 230). For example, the network entity 105 may transmit multiple downlink or uplink grants to multiple UEs 115, where each UE 115 is configured with a corresponding uplink or downlink grant. The network entity 105 may accordingly use the DCI 225 conveyed via the PDCCH to first address all or the group of UEs 115, and the network entity 105 may subsequently use the DCI 235 on the PDSCH 230 to transfer specific DCI (e.g., the uplink or downlink grant) for each of the specific UEs 115. The PDSCH 230 may accordingly be received by all or the group of addressed UEs 115. The PDCCH that conveys the DCI 225 may be associated with an SS and/or a CORESET configured for all or the group of UEs 115 (e.g., in RRC signaling).

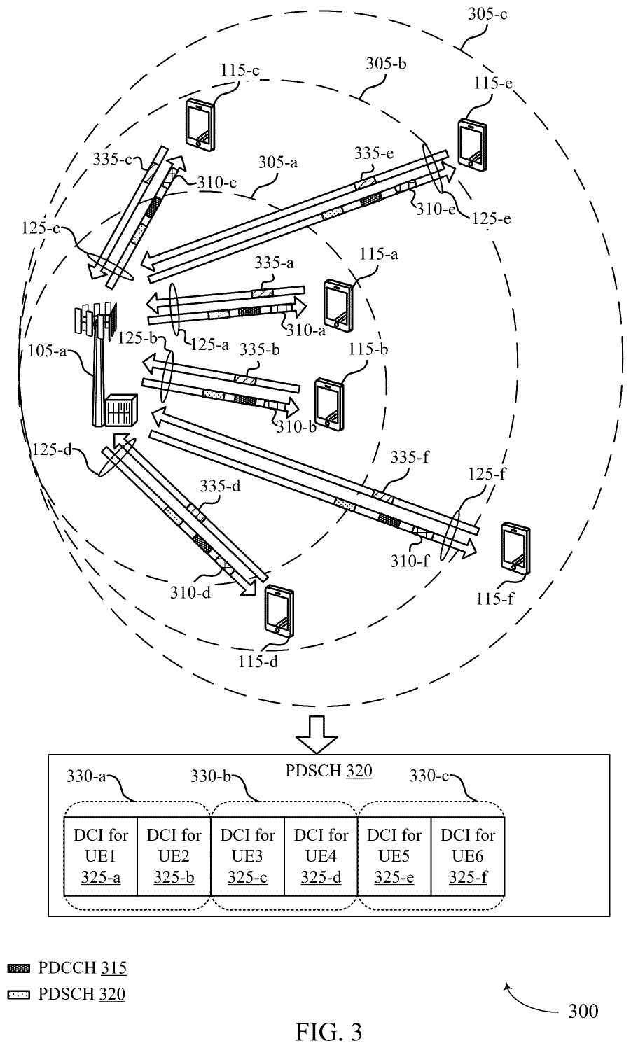

FIG. 3 shows an example of a wireless communications system 300 that supports broadcast and multicast DCI via PDSCH in accordance with one or more aspects of the present disclosure. The wireless communications system 300 may implement or may be implemented by aspects of the wireless communications system 100, the resource diagram 200, or the resource diagram 220.

The network entity 105-a may communicate with the UE 115-a via a communication link 125-a, which may be an example of an NR or LTE link between the UE 115-a and the network entity 105-a. The network entity 105-a may communicate with the UE 115-b via a communication link 125-b, which may be an example of an NR or LTE link between the UE 115-b and the network entity 105-a. The network entity 105-a may communicate with the UE 115-c via a communication link 125-c, which may be an example of an NR or LTE link between the UE 115-c and the network entity 105-a. The network entity 105-a may communicate with the UE 115-d via a communication link 125-d, which may be an example of an NR or LTE link between the UE 115-d and the network entity 105-a. The network entity 105-a may communicate with the UE 115-e via a communication link 125-e, which may be an example of an NR or LTE link between the UE 115-e and the network entity 105-a. The network entity 105-a may communicate with the UE 115-f via a communication link 125-f, which may be an example of an NR or LTE link between the UE 115-f and the network entity 105-a. In some cases, the communication link 125-a, the communication link 125-b, the communication link 125-c, the communication link 125-d, the communication link 125-e, and the communication link 125-f may include examples of an access link (e.g., a Uu link).

The communication link 125-a, the communication link 125-b, the communication link 125-c, the communication link 125-d, the communication link 125-e, and the communication link 125-f may each include a bi-directional link that enables both uplink and downlink communication. For example, the UE 115-a may transmit uplink signals, such as uplink control signals or uplink data signals, to the network entity 105-a using the communication link 125-a, and the network entity 105-a may transmit downlink signals, such as downlink control signals or downlink data signals, to the UE 115-a using the communication link 125-a. The UE 115-b may transmit uplink signals, such as uplink control signals or uplink data signals, to the network entity 105-a using the communication link 125-b, and the network entity 105-a may transmit downlink signals, such as downlink control signals or downlink data signals, to the UE 115-b using the communication link 125-b. The UE 115-c may transmit uplink signals, such as uplink control signals or uplink data signals, to the network entity 105-a using the communication link 125-c, and the network entity 105-a may transmit downlink signals, such as downlink control signals or downlink data signals, to the UE 115-c using the communication link 125-c. The UE 115-d may transmit uplink signals, such as uplink control signals or uplink data signals, to the network entity 105-a using the communication link 125-d, and the network entity 105-a may transmit downlink signals, such as downlink control signals or downlink data signals, to the UE 115-d using the communication link 125-d. The UE 115-e may transmit uplink signals, such as uplink control signals or uplink data signals, to the network entity 105-a using the communication link 125-e, and the network entity 105-a may transmit downlink signals, such as downlink control signals or downlink data signals, to the UE 115-e using the communication link 125-e. The UE 115-f may transmit uplink signals, such as uplink control signals or uplink data signals, to the network entity 105-a using the communication link 125-f, and the network entity 105-a may transmit downlink signals, such as downlink control signals or downlink data signals, to the UE 115-f using the communication link 125-f.

The UEs 115 may be located in coverage regions 305 within the coverage area of the network entity 105-a. For example, UEs 115 within a first coverage region 305-a may correspond to a region with lower interference and/or pathloss between UEs 115 and the network entity 105-a, a second coverage region 305-b may correspond to a region with higher interference and/or pathloss between UEs 115 and the network entity 105-a, and a third coverage region 305-c may correspond to a region with even higher interference and/or pathloss between UEs 115 and the network entity 105-a. For example, UEs 115 that are closer to the cell center (e.g., physically closer to the network entity 105-a) may generally have lower pathloss and interference than cell-edge UEs 115. For example, the UE 115-a and the UE 115-b may be located within the first coverage region 305-a, the UE 115-c and the UE 115-d may be located within the second coverage region 305-b, and the UE 115-e and the UE 115-f may be located within the third coverage region 305-c.

In some aspects, to transmit DCI to the various UEs 115 within the coverage area of the network entity 105-a, the network entity 105-a may use different aggregation levels for PDCCH to serve each UE 115 with a specific target code rate. For example, cell-centered UEs 115 (e.g., the UE 115-a and the UE 115-b) may be served with low aggregation levels (e.g., high code rates) due to the low pathloss and/or interference for the cell-center UEs 115, and cell-edge UEs 115 (e.g., the UE 115-e and the UE 115-f) may be served with high aggregation levels (e.g., low code rates) due to high pathloss and/or interference for cell-edge UEs 115. Target code rate may be controlled via MCS. For example, MCS may define the quantity of useful bits (e.g., data bits) transmitted per resource element. MCS may define the modulation order (e.g., the quantity of bits per resource element) and the code rate (e.g., the ratio between useful bits and redundant bits).

As described herein, the network entity 105-a may perform two-part DCI, in which a PDCCH 315 may include a first DCI for the UEs (115) which may indicate scheduling information for a PDSCH 320, and the PDSCH 320 may include multiple DCI components 325 for the multiple UEs 115 (e.g., a DCI component 325-a may be targeted for the UE 115-a, a DCI component 325-b may be targeted for the UE 115-b, a DCI component 325-c may be targeted for the UE 115-c, a DCI component 325-d may be targeted for the UE 115-d, a DCI component 325-e may be targeted for the UE 115-e, and a DCI component 325-f may be targeted for the UE 115-f). The network entity 105-a may group UEs 115, and accordingly DCI components 325 within the PDSCH 320 into groups 330, based on a target code rate (e.g., based on the MCS) for each UE 115 (e.g., based on the coverage region 305 in which the UEs 115 are located).

For example, the PDCCH 315 may be a broadcast or multicast PDCCH, and the PDSCH 320 scheduled by DCI conveyed via the PDCCH 315 may be a broadcast or multicast PDSCH targeting the UEs 115. The PDSCH 320 may aggregate the different DCI components 325 into different groups 330 and may use group-specific MCSs to encode the different groups 330. For example, the UE 115-a and the UE 115-b may be grouped into a first group 330-a (e.g., based on being within the first coverage region 305-a or based on a first target MCS), the UE 115-c and the UE 115-d may be grouped into a second group 330-b (e.g., based on being within the second coverage region 305-b or based on a first target MCS), and the UE 115-e and the UE 115-f may be grouped into a third group 330-c (e.g., based on being within the third coverage region 305-c or based on a third target MCS). For example, the UEs 115 may be grouped based on the network entity 105-a determining a location of the UEs 115 (e.g., based on positioning reference signals). As another example, the UEs 115 may be grouped based on a target MCS based on channel state information (CSI) reporting (e.g., based on CSI reports from the UEs 115 to the network entity 105-a based on measurements by the UEs 115 of CSI reference signals (CSI-RSs) transmitted by the network entity 105-a) or based on measurements by the network entity 105-a of sounding reference signals (SRSs) transmitted by the UEs 115.

For example, the different DCI components 325 may be aggregated into different codewords or transport blocks with corresponding CRC bits within a same broadcast or multicast PDSCH. For example, within the PDSCH 320, the DCI component 325-a and the DCI component 325-b may be aggregated into a first codeword encoded using a first MCS, the DCI component 325-c and the DCI component 325-d may be aggregated into a second codeword encoded using a second MCS, and the DCI component 325-e and the DCI component 325-f may be aggregated into a third codeword encoded using a third MCS.

The DCI components 325 may include information particular to the particular target UE 115. For example, the DCI component 325-a may include scheduling information for a subsequent shared channel communication 335-a for the UE 115-a, the DCI component 325-b may include scheduling information for a subsequent shared channel communication 335-b for the UE 115-b, the DCI component 325-c may include scheduling information for a subsequent shared channel communication 335-c for the UE 115-c, the DCI component 325-d may include scheduling information for a subsequent shared channel communication 335-d for the UE 115-d, the DCI component 325-e may include scheduling information for a subsequent shared channel communication 335-e for the UE 115-e, and the DCI component 325-f may include scheduling information for a subsequent shared channel communication 335-f for the UE 115-f. While the shared channel communications 335 are shown in FIG. 3 as uplink shared channel communications, the DCI components 325 may include scheduling information for uplink shared channel communications or for downlink shared channel communications. In some aspects, the DCI components 325 may include other control information, such as power control information for a particular UE 115.

In some aspects, the PDSCH 320 may include a DMRS that may be shared by all of the UEs 115. In some such aspects, the DMRS may be scrambled by a group-common (e.g., possibly temporary) RNTI. In some such aspects, the network entity 105-a may indicate the group-common RNTI in control signaling 310 (e.g., RRC signaling). For example, control signaling 310 may indicate a UE identifier (e.g., an RNTI) for each UE 115. For example, the UE 115-a may be associated with a first UE identifier as indicated in control signaling 310-a between the UE 115-a and the network entity 105-a, the UE 115-b may be associated with a second UE identifier as indicated in control signaling 310-b between the UE 115-b and the network entity 105-a, the UE 115-c may be associated with a third UE identifier as indicated in control signaling 310-c between the UE 115-c and the network entity 105-a, the UE 115-d may be associated with a fourth UE identifier as indicated in control signaling 310-d between the UE 115-d and the network entity 105-a, the UE 115-e may be associated with a fifth UE identifier as indicated in control signaling 310-e between the UE 115-e and the network entity 105-a, and the UE 115-e may be associated with a sixth UE identifier as indicated in control signaling 310-f between the UE 115-f and the network entity 105-a. Each DCI component 325 may include a CRC scrambled by the UE identifier (e.g., the RNTI) associated with the target UE 115. For example, the DCI component 325-a may include a CRC scrambled by the UE identifier configured for the UE 115-a, the DCI component 325-b may include a CRC scrambled by the UE identifier configured for the UE 115-b, the DCI component 325-c may include a CRC scrambled by the UE identifier configured for the UE 115-c, the DCI component 325-d may include a CRC scrambled by the UE identifier configured for the UE 115-d, the DCI component 325-e may include a CRC scrambled by the UE identifier configured for the UE 115-e, and the DCI component 325-f may include a CRC scrambled by the UE identifier configured for the UE 115-f. Accordingly, each particular UE 115 may determine which DCI component 325 is associated with the particular UE 115 based on the CRC of the DCI component 325 being scrambled by the configured UE identifier for the particular UE.

In some aspects, the CRC of each codeword or transport block (e.g., each of the encoded groups 330 of DCI components 325) may be scrambled with a respective temporary RNTI for the group. For example, the control signaling 310 may indicate the respective temporary RNTI for the groups of UEs 115 (e.g., the group of UEs 115 associated with a same target MCS). For example, the first group 330-a of DCI components 325 may include a CRC scrambled with a first temporary RNTI, the second group 330-b of DCI components 325 may include a CRC scrambled with a second temporary RNTI, and the third group 330-c of DCI components 325 may include a CRC scrambled with a third temporary RNTI. For example, the network entity 105-a may indicate the first temporary RNTI to the UE 115-a and the UE 115-b, the network entity 105-a may indicate the second temporary RNTI to the UE 115-c and the UE 115-d, and the network entity 105-a may indicate the third temporary RNTI to the UE 115-e and the UE 115-f. Accordingly, the UE 115-a and the UE 115-b may identify that the first group 330-a includes DCI components 325 that correspond to the UE 115-a and the UE 115-b based on the CRC for the first group 330-a being scrambled by the first temporary RNTI. Similarly, the UE 115-c and the UE 115-d may identify that the second group 330-b includes DCI components 325 that correspond to the UE 115-c and the UE 115-d based on the CRC for the second group 330-b being scrambled by the second temporary RNTI, and the UE 115-e and the UE 115-f may identify that the third group 330-c includes DCI components 325 that correspond to the UE 115-e and the UE 115-f based on the CRC for the third group 330-c being scrambled by the third temporary RNTI.

Accordingly, a particular UE 115 may identify which group 330 of DCI components 325 is associated with the particular UE 115 based on the group identifier (e.g., the temporary RNTI) configured for the particular UE 115 being used to scramble the CRC for the group 330 of DCI components 325, and within a group 330, a particular UE 115 may determine which DCI component 325 is associated with the particular UE based on the UE identifier (e.g., RNTI) for the particular UE being used to scramble the CRC of the DCI component 325.

In some aspects, as DCI information may be time-sensitive, a HARQ-ACK process may not be activated for the PDSCH 320 where the PDSCH 320 is a broadcast or multicast DCI only PDSCH (e.g., only conveys DCI components for multiple UEs 115). In some aspects, as the HARQ-ACK process may not be activated for the PDSCH 320, some or all of the HARQ-ACK process fields in the first DCI conveyed via the PDCCH 315 may be repurposed to signal information about the PDSCH 320 (e.g., such as: an indication of a quantity of codewords or transport blocks (e.g., a quantity of groups 330 of DCI components 325) in the PDSCH 320; the TDRA of the PDSCH 320; the FDRA of the PDSCH 320; the MCS of each codeword or transport block (e.g., an MCS for each of the groups 330); the rank of the PDSCH 320; a payload size of each of the DCI components 325; a code rate of each codeword or transport block (e.g., a code rate for each of the groups 330); and/or a DMRS configuration for the PDSCH 320). As one example, the bit-field for the HARQ process identifier in the first DCI conveyed via the PDCCH 315 may be repurposed to signal the quantity of codewords or transport blocks (e.g., a quantity of groups 330 of DCI components 325) in the PDSCH 320.

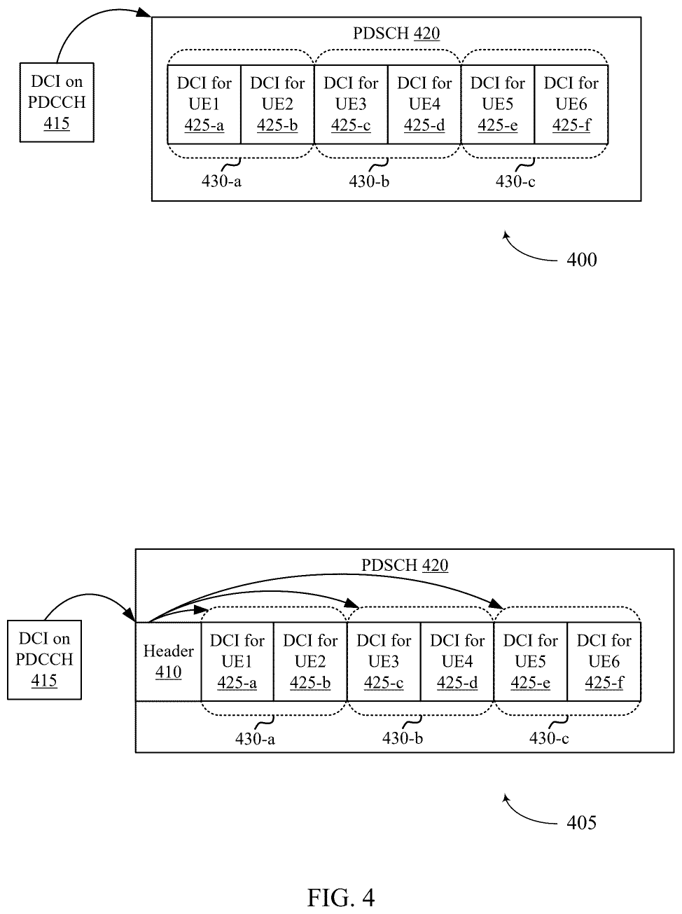

FIG. 4 shows an example of a two-part DCI diagram 400 and a two-part DCI diagram 405 that supports broadcast and multicast DCI via PDSCH in accordance with one or more aspects of the present disclosure. The two-part DCI diagram 400 and the two-part DCI diagram 405 may implement or may be implemented by aspects of the wireless communications system 100, the resource diagram 200, the resource diagram 220, or the wireless communications system 300.

As described herein, a network entity 105 may perform two-part DCI, in which a first DCI 415 conveyed via a PDCCH may indicate, to multiple UEs 115, scheduling information for a PDSCH 420. The PDSCH 420 may include multiple DCI components 425 for the multiple UEs 115 (e.g., a DCI component 425-a may be targeted for a first UE 115 such as the UE 115-a as described with reference to FIG. 3, a DCI component 425-b may be targeted for a second UE 115 such as the UE 115-b as described with reference to FIG. 3, a DCI component 425-c may be targeted for a third UE 115 such as the UE 115-c as described with reference to FIG. 3, a DCI component 425-d may be targeted for a fourth UE 115 such as the UE 115-d as described with reference to FIG. 3, a DCI component 425-e may be targeted for a fifth UE 115 such as the UE 115-e as described with reference to FIG. 3, and a DCI component 425-f may be targeted for a sixth UE 115 such as the UE 115-f as described with reference to FIG. 3). The network entity 105 may group UEs 115, and accordingly DCI components 425 within the PDSCH 420 into groups 430, based on a target code rate (e.g., based on the target MCS) for each UE 115.

In some aspects, as shown in the two-part DCI diagram 400, the first DCI 415 may include information regarding the PDSCH 420. For example, the first DCI may include one or more of: an indication of a quantity of codewords or transport blocks (e.g., a quantity of groups 430 of DCI components 425) in the PDSCH 420; the TDRA of the PDSCH 420; the FDRA of the PDSCH 420; the MCS of each codeword or transport block (e.g., an MCS for each of the groups 430); the rank of the PDSCH 420; a payload size of each of the DCI components 425; a code rate of each codeword or transport block (e.g., a code rate for each of the groups 430); and/or a DMRS configuration for the PDSCH 420. As described herein, the PDSCH 420 may be a broadcast or multicast only PDSCH.

In some aspects, the network entity 105 may use a fixed modulation order for all of the codewords or transport blocks (e.g., all of the groups 430 of DCI components 425) within the PDSCH 420. In some such aspects, the network entity 105 may indicate the fixed modulation order in the first DCI 415.

In some aspects, the CRC of each codeword or transport block (e.g., each of the encoded groups 430 of DCI components 425) may be scrambled with a respective temporary RNTI for the group. For example, the first group 430-a of DCI components 425 may include a CRC scrambled with a first temporary RNTI, the second group 430-b of DCI components 425 may include a CRC scrambled with a second temporary RNTI, and the third group 430-c of DCI components 425 may include a CRC scrambled with a third temporary RNTI. The network entity 105 may indicate the relevant temporary RNTIs to the UEs 115 in control signaling (e.g., RRC signaling such as the control signaling 310 as described with reference to FIG. 3). For example, the network entity 105 may indicate the first temporary RNTI to the UE 115-a and the UE 115-b, the network entity 105 may indicate the second temporary RNTI to the UE 115-c and the UE 115-d, and the network entity 105 may indicate the third temporary RNTI to the UE 115-e and the UE 115-f. Accordingly, the UE 115-a and the UE 115-b may identify that the first group 430-a includes DCI components 425 that correspond to the UE 115-a and the UE 115-b based on the CRC for the first group 430-a being scrambled by the first temporary RNTI. Similarly, the UE 115-c and the UE 115-d may identify that the second group 430-b includes DCI components 425 that correspond to the UE 115-c and the UE 115-d based on the CRC for the second group 430-b being scrambled by the second temporary RNTI, and the UE 115-e and the UE 115-f may identify that the third group 430-c includes DCI components 425 that correspond to the UE 115-e and the UE 115-f based on the CRC for the third group 430-c being scrambled by the third temporary RNTI.

In some aspects, as shown in the as shown in the two-part DCI diagram 405, the PDSCH 420 may include a header 410. Some information about the PDSCH 420 may be indicated in the header 410. For example, if signaling overhead for signaling parameters of the PDSCH 420 is large and exceeds the payload size of the first DCI 415, some of the parameter information for the PDSCH 420 may be indicated or signaled in the header 410. For example, the header 410 may include one or more of: an indication of a quantity of codewords or transport blocks (e.g., a quantity of groups 430 of DCI components 425) in the PDSCH 420; the MCS of each codeword or transport block (e.g., an MCS for each of the groups 430); a payload size of each of the DCI components 425; a code rate of each codeword or transport block (e.g., a code rate for each of the groups 430); and/or a TDRA and/or FDRA for each of the codewords or transport blocks (e.g., for each of the groups 430 of DCI components 425). As described herein, the PDSCH 420 may be a broadcast or multicast only PDSCH.

In some aspects, the network entity 105 may include information about the header 410, such as the DMRS configuration of the header 410, the TDRA of the header, the FDRA of the header 410, the MCS of the header 410, the modulation order of the header 410, and/or the code rate of the header 410 in the first DCI 415 that schedules the PDSCH 420 that includes the header 410. The header 410 may be a separate codeword with a separate CRC than the codewords or transport blocks that include the DCI components 425, and accordingly the first DCI 415 may include information regarding decoding the header 410. Accordingly, inclusion of the header 410 may result in an additional transport block being included in the PDSCH 420.

In some aspects, the CRC of the header 410 may be scrambled with a temporary group-RNTI (e.g., such that all UEs 115 may be able to decode the header 410). For example, the temporary group-RNTI may be signaled to UEs 115 (e.g., the UEs 115 targeted in the PDSCH 420) via the control signaling 310 as described with reference to FIG. 3 (e.g., RRC signaling). In some aspects, a single DMRS may be used (e.g., shared) to decode both the header 410 and each of the codewords or transport blocks in the PDSCH 420 (e.g., each of the groups 430 of DCI components 425). For example, the DMRS may be scrambled by a temporary group-RNTI which may be signaled to UEs 115 (e.g., the UEs 115 targeted in the PDSCH 420) via the control signaling 310 as described with reference to FIG. 3 (e.g., RRC signaling).

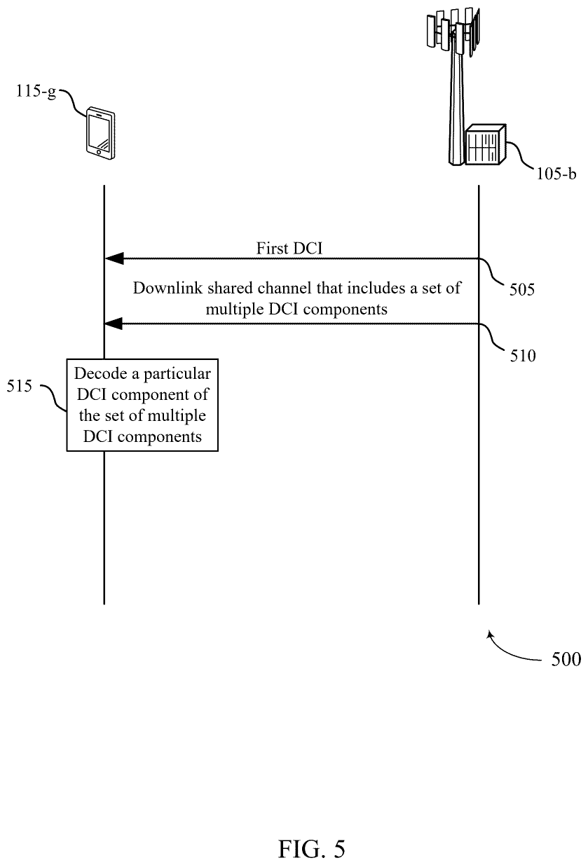

FIG. 5 shows an example of a process flow 500 that supports broadcast and multicast DCI via PDSCH in accordance with one or more aspects of the present disclosure. The process flow 500 may implement or may be implemented by aspects of the wireless communications system 100, the resource diagram 200, the resource diagram 220, the wireless communications system 300, the two-part DCI diagram 400, or the two-part DCI diagram 405. For example, the process flow 500 may include a UE 115-g and a network entity 105-b, which may be an example of a UE 115 and a network entity 105 as described herein. In the following description of the process flow 500, the operations performed by the UE 115-g and the network entity 105-b may be performed in different orders or at different times than the exemplary order shown. Some operations may also be omitted from the process flow 500, or other operations may be added to the process flow 500. Further, while operations in the process flow 500 are illustrated as being performed by the UE 115-g and the network entity 105-b, the examples herein are not to be construed as limiting, as the described features may be associated with any quantity of different devices.

At 505, the network entity 105-b may output, and the UE 115-g may receive, first DCI via a downlink control channel (e.g., a PDCCH) transmission. The first DCI may indicate first scheduling information for a downlink shared channel transmission (e.g., for a PDSCH). The first DCI may indicate that the downlink shared channel transmission is scheduled to convey a set of multiple second DCI components.

At 510, the network entity 105-b may output, and the UE 115-g may receive, the downlink shared channel transmission in accordance with the first scheduling information. The downlink shared channel transmission may include a set of multiple DCI components organized into a set of multiple groups. Each DCI component of the set of multiple DCI components may include respective DCI associated with a respective UE 115 of a set of multiple UEs 115 and a respective group of the set of multiple groups. The set of multiple UEs 115 may include the UE 115-g. Each group of the set of multiple groups may be associated with a different respective MCS.

At 515, the UE 115-g may decode a particular DCI component of the set of multiple DCI components.

In some aspects, the set of multiple groups includes a first group and a second group, the first group includes a first subset of DCI components of the set of multiple DCI components, and the second group includes a second subset of DCI components of the set of multiple DCI components. In some aspects, the first subset of DCI components includes a first DCI component and a second DCI component, the second subset of DCI components includes a third DCI component, the first DCI component and the second DCI component are encoded with a first MCS, and the third DCI component is encoded with a second MCS different than the first MCS. In some aspects, the second subset of DCI components includes a fourth DCI component, and the fourth DCI component is encoded with the second MCS.

In some aspects, the UE 115-b may decode the particular DCI component at 515 based on: determining that a particular group includes a first CRC scrambled by a group identifier (e.g., a temporary RNTI as described herein), where the particular group includes the particular DCI component; and determining that the particular DCI component includes a second CRC scrambled by a device identifier (e.g., a UE identifier such as an RNTI) associated with the UE 115-g. In some aspects, the network entity 105-b may output, and the UE 115-g may receive, information indicative of the group identifier and the device identifier, where the group identifier and the device identifier are associated with the UE 115-g.

In some aspects, the particular DCI component may schedule a subsequent shared channel transmission (e.g., a PUSCH transmission or a PDSCH transmission), and the UE 115-g and the network entity 105-b may perform the subsequent shared channel transmission in accordance with the particular DCI component.

In some aspects, the first DCI may indicate one or more of: a quantity of groups of the set of multiple groups; a TDRA of the downlink shared channel transmission; an FDRA of the downlink shared channel transmission; a rank of the downlink shared channel transmission; a respective payload size of each DCI component of the set of multiple DCI components; a respective code rate for each respective group of the set of multiple groups; or a DMRS configuration for the downlink shared channel transmission.

In some aspects, the first DCI may include an indication of a modulation order of the set of multiple groups.

In some aspects, the network entity 105-b may output, and the UE 115-g may receive, an indication of a group identifier associated with a group of UEs 115, the group of UEs 115 including the UE 115-g. The group of UEs 115 may include the set of multiple UEs 115. In some such aspects, the downlink shared channel transmission may include a single DMRS associated with the set of multiple groups, and the single DMRS may be scrambled by the group identifier.

In some aspects, at least a portion of the first scheduling information may be conveyed via one or more repurposed HARQ fields of the first DCI.

In some aspects, the downlink shared channel transmission may include a header associated with the set of multiple groups. In some aspects, the header may indicate one or more of: a quantity of groups of the set of multiple groups; a respective payload size of each DCI component of the set of multiple DCI components; a respective code rate for each respective group of the set of multiple groups; a DMRS configuration for the downlink shared channel transmission; a respective TDRA for each group of the set of multiple groups; or a respective FDRA for each group of the set of multiple groups. In some aspects, the first DCI may include header information associated with the header. In some aspects, the first information may indicate one or more of: a code rate for the header; a TDRA for the header; an FDRA for the header; or a DMRS configuration for the header.

In some aspects, the network entity 105-b may output, and the UE 115-g may receive, an indication of a group identifier associated with a group of UEs 115.

The group of UEs 115 may include the UE 115-b, and the header may include a CRC scrambled by the group identifier. The group of UEs 115 may include the set of multiple UEs 115. In some aspects, the downlink shared channel transmission may include a single DMRS associated with the set of multiple groups and the header.

In some aspects, the downlink shared channel transmission may be a broadcast DCI only PDSCH transmission or a multicast DCI only PDSCH transmission.

In some aspects, the downlink shared channel transmission may be a PDSCH transmission.

In some aspects, respective DCI components of each group of the set of multiple groups may be encoded as a respective transport block via the different respective MCS.

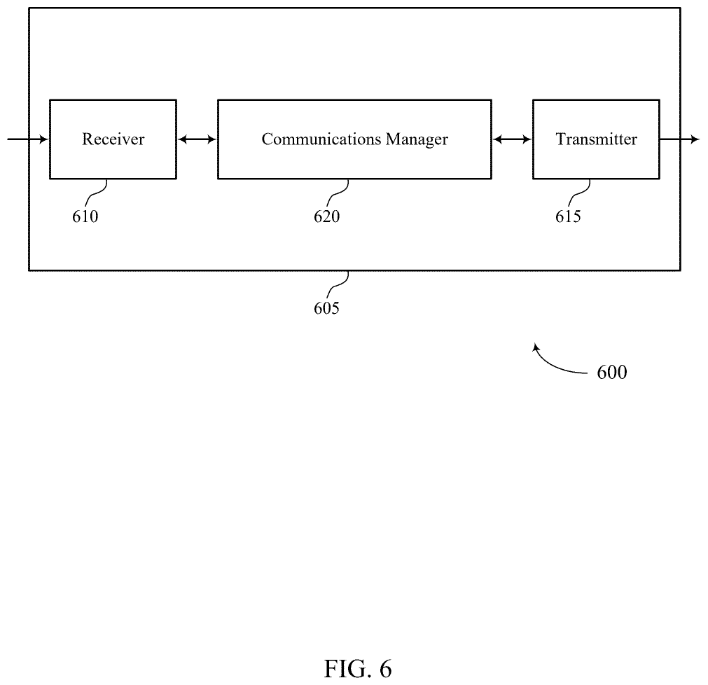

FIG. 6 shows a block diagram 600 of a device 605 that supports broadcast and multicast DCI via PDSCH in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to broadcast and multicast DCI via PDSCH). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to broadcast and multicast DCI via PDSCH). In some aspects, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of broadcast and multicast DCI via PDSCH as described herein. For example, the communications manager 620, the receiver 610, the transmitter 615, or various combinations or components thereof may be capable of performing one or more of the functions described herein.

In some aspects, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving first DCI via a downlink control channel transmission, where the first DCI indicates first scheduling information for a downlink shared channel transmission, and where the first DCI indicates that the downlink shared channel transmission is scheduled to convey a set of multiple second DCI components. The communications manager 620 is capable of, configured to, or operable to support a means for receiving the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective MCS. The communications manager 620 is capable of, configured to, or operable to support a means for decoding a particular DCI component of the set of multiple DCI components.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

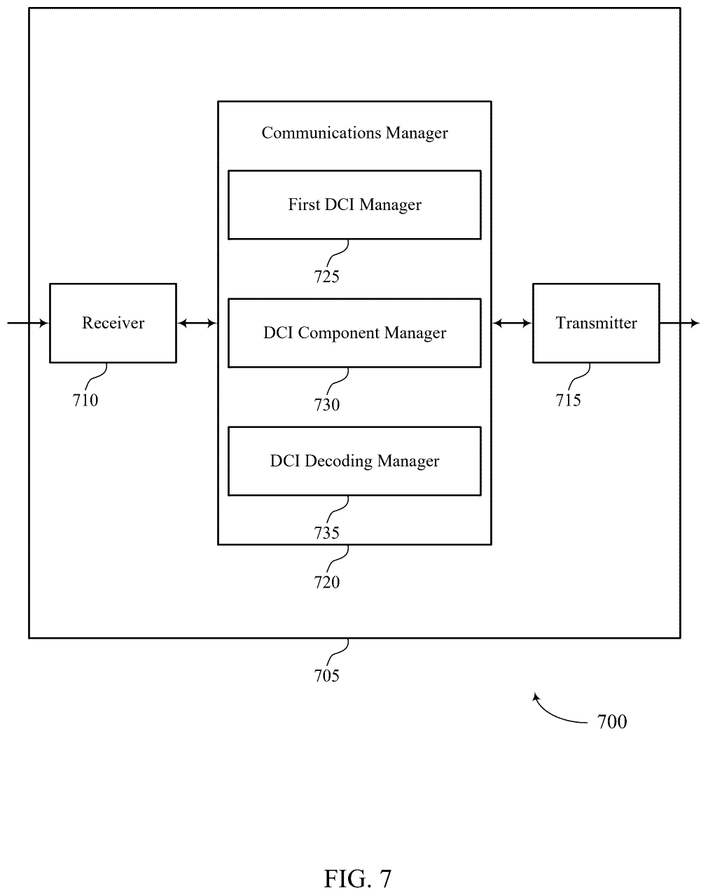

FIG. 7 shows a block diagram 700 of a device 705 that supports broadcast and multicast DCI via PDSCH in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to broadcast and multicast DCI via PDSCH). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to broadcast and multicast DCI via PDSCH). In some aspects, the transmitter 715 may be co-located with a receiver 710 in a transceiver module. The transmitter 715 may utilize a single antenna or a set of multiple antennas.

The device 705, or various components thereof, may be an example of means for performing various aspects of broadcast and multicast DCI via PDSCH as described herein. For example, the communications manager 720 may include a first DCI manager 725, a DCI component manager 730, a DCI decoding manager 735, or any combination thereof. The communications manager 720 may be an example of aspects of a communications manager 620 as described herein. In some aspects, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The first DCI manager 725 is capable of, configured to, or operable to support a means for receiving first DCI via a downlink control channel transmission, where the first DCI indicates first scheduling information for a downlink shared channel transmission, and where the first DCI indicates that the downlink shared channel transmission is scheduled to convey a set of multiple second DCI components. The DCI component manager 730 is capable of, configured to, or operable to support a means for receiving the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective MCS. The DCI decoding manager 735 is capable of, configured to, or operable to support a means for decoding a particular DCI component of the set of multiple DCI components.

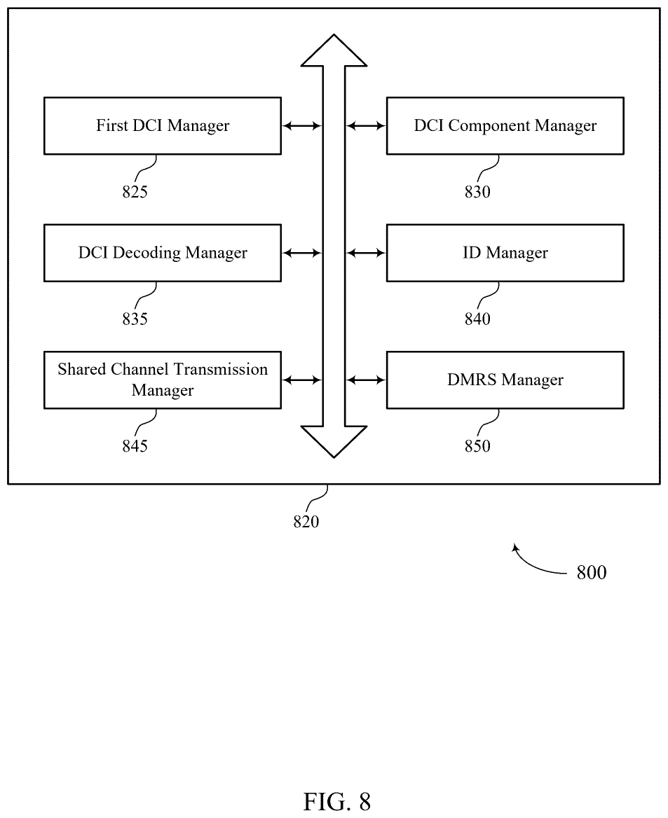

FIG. 8 shows a block diagram 800 of a communications manager 820 that supports broadcast and multicast DCI via PDSCH in accordance with one or more aspects of the present disclosure. The communications manager 820 may be an example of aspects of a communications manager 620, a communications manager 720, or both, as described herein. The communications manager 820, or various components thereof, may be an example of means for performing various aspects of broadcast and multicast DCI via PDSCH as described herein. For example, the communications manager 820 may include a first DCI manager 825, a DCI component manager 830, a DCI decoding manager 835, an ID manager 840, a shared channel transmission manager 845, a DMRS manager 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The first DCI manager 825 is capable of, configured to, or operable to support a means for receiving first DCI via a downlink control channel transmission, where the first DCI indicates first scheduling information for a downlink shared channel transmission, and where the first DCI indicates that the downlink shared channel transmission is scheduled to convey a set of multiple second DCI components. The DCI component manager 830 is capable of, configured to, or operable to support a means for receiving the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective MCS. The DCI decoding manager 835 is capable of, configured to, or operable to support a means for decoding a particular DCI component of the set of multiple DCI components.

In some aspects, the set of multiple groups includes a first group and a second group. In some aspects, the first group includes a first subset of DCI components of the set of multiple DCI components. In some aspects, the second group includes a second subset of DCI components of the set of multiple DCI components.

In some aspects, the first subset of DCI components includes a first DCI component and a second DCI component. In some aspects, the second subset of DCI components includes a third DCI component. In some aspects, the first DCI component and the second DCI component are encoded with a first MCS. In some aspects, the third DCI component is encoded with a second MCS different than the first MCS.

In some aspects, the second subset of DCI components includes a fourth DCI component. In some aspects, the fourth DCI component is encoded with the second MCS.

In some aspects, to support decoding the particular DCI component, the ID manager 840 is capable of, configured to, or operable to support a means for determining that a particular group includes a first CRC scrambled by a group identifier, where the particular group includes the particular DCI component. In some aspects, to support decoding the particular DCI component, the ID manager 840 is capable of, configured to, or operable to support a means for determining that the particular DCI component includes a second CRC scrambled by a device identifier associated with the first network entity.

In some aspects, the ID manager 840 is capable of, configured to, or operable to support a means for receive information indicative of the group identifier and the device identifier, where the group identifier and the device identifier are associated with the first network entity.

In some aspects, the first network entity may decode the particular DCI component based on: a particular group that includes the particular DCI component including a first CRC scrambled by a group identifier, where the particular group includes the particular DCI component; and the particular DCI component including a second CRC scrambled by a device identifier associated with the first network entity.

In some aspects, the shared channel transmission manager 845 is capable of, configured to, or operable to support a means for performing a subsequent shared channel transmission in accordance with the particular DCI component, where the particular DCI component schedules the subsequent shared channel transmission.

In some aspects, the first DCI indicates one or more of: a quantity of groups of the set of multiple groups; a TDRA of the downlink shared channel transmission; an FDRA of the downlink shared channel transmission; a rank of the downlink shared channel transmission; a respective payload size of each DCI component of the set of multiple DCI components; a respective code rate for each respective group of the set of multiple groups; or a DMRS configuration for the downlink shared channel transmission.

In some aspects, the first DCI includes an indication of a modulation order of the set of multiple groups.

In some aspects, the ID manager 840 is capable of, configured to, or operable to support a means for receiving an indication of a group identifier associated with the set of multiple network entities, where the downlink shared channel transmission includes a single DMRS associated with the set of multiple groups, where the single DMRS is scrambled by the group identifier.

In some aspects, at least a portion of the first scheduling information is conveyed via one or more repurposed HARQ fields of the first DCI.

In some aspects, the downlink shared channel transmission includes a header associated with the set of multiple groups.

In some aspects, the header indicates: a quantity of groups of the set of multiple groups; a respective payload size of each DCI component of the set of multiple DCI components; a respective code rate for each respective group of the set of multiple groups; a DMRS configuration for the downlink shared channel transmission; a respective TDRA for each group of the set of multiple groups; or a respective FDRA for each group of the set of multiple groups.

In some aspects, the first DCI includes header information associated with the header.

In some aspects, a code rate for the header; a TDRA for the header; an FDRA for the header; or a DMRS configuration for the header.

In some aspects, the ID manager 840 is capable of, configured to, or operable to support a means for receiving an indication of a group identifier associated with includes the set of multiple network entities, where the header includes a CRC scrambled by the group identifier.

In some aspects, the DMRS manager 850 is capable of, configured to, or operable to support a means for receiving, via the downlink shared channel transmission, a single DMRS associated with the set of multiple groups and the header.

In some aspects, the downlink shared channel transmission is a broadcast DCI only PDSCH transmission or a multicast DCI only PDSCH transmission.

In some aspects, the downlink shared channel transmission is a PDSCH transmission.

In some aspects, respective DCI components of each group of the set of multiple groups are encoded as a respective transport block via the different respective MCS.

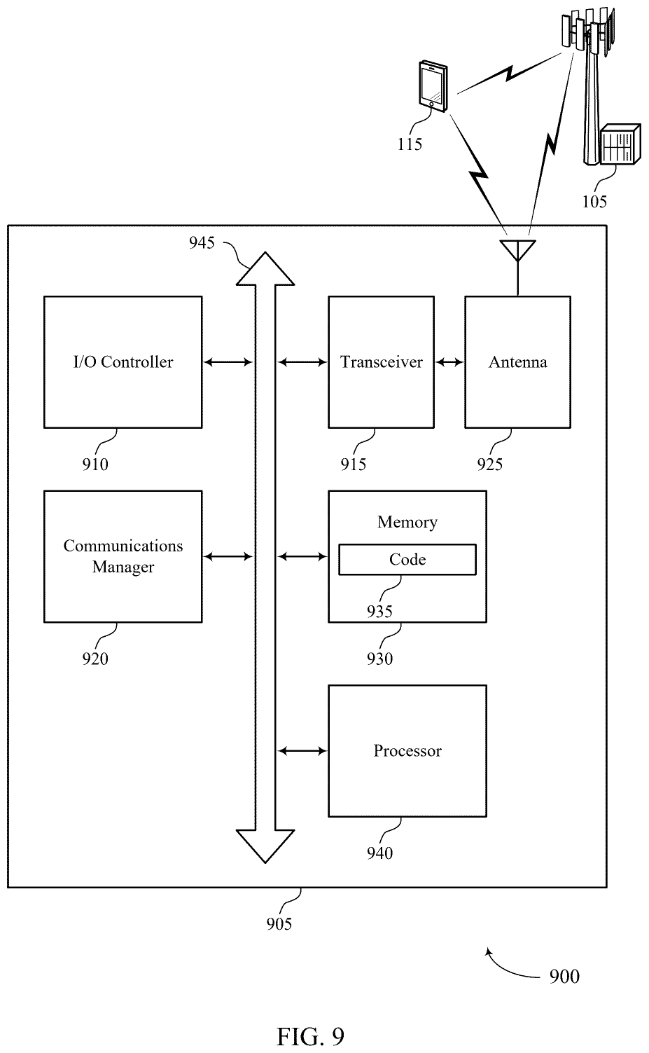

FIG. 9 shows a diagram of a system 900 including a device 905 that supports broadcast and multicast DCI via PDSCH in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting broadcast and multicast DCI via PDSCH). For example, the device 905 or a component of the device 905 may include at least one processor 940 and at least one memory 930 coupled with or to the at least one processor 940, the at least one processor 940 and the at least one memory 930 configured to perform various functions described herein.

In some aspects, the at least one processor 940 may include multiple processors and the at least one memory 930 may include multiple memories. One or more of the multiple processors may be coupled with one or more of the multiple memories, which may, individually or collectively, be configured to perform various functions described herein. In some aspects, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving first DCI via a downlink control channel transmission, where the first DCI indicates first scheduling information for a downlink shared channel transmission, and where the first DCI indicates that the downlink shared channel transmission is scheduled to convey a set of multiple second DCI components. The communications manager 920 is capable of, configured to, or operable to support a means for receiving the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective MCS. The communications manager 920 is capable of, configured to, or operable to support a means for decoding a particular DCI component of the set of multiple DCI components.

By including or configuring the communications manager 920 in accordance with examples as described herein, the device 905 may support techniques for improved communication reliability, more efficient utilization of communication resources, and improved coordination between devices.

In some aspects, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, In some aspects, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of broadcast and multicast DCI via PDSCH as described herein, or the at least one processor 940 and the at least one memory 930 may be otherwise configured to, individually or collectively, perform or support such operations.

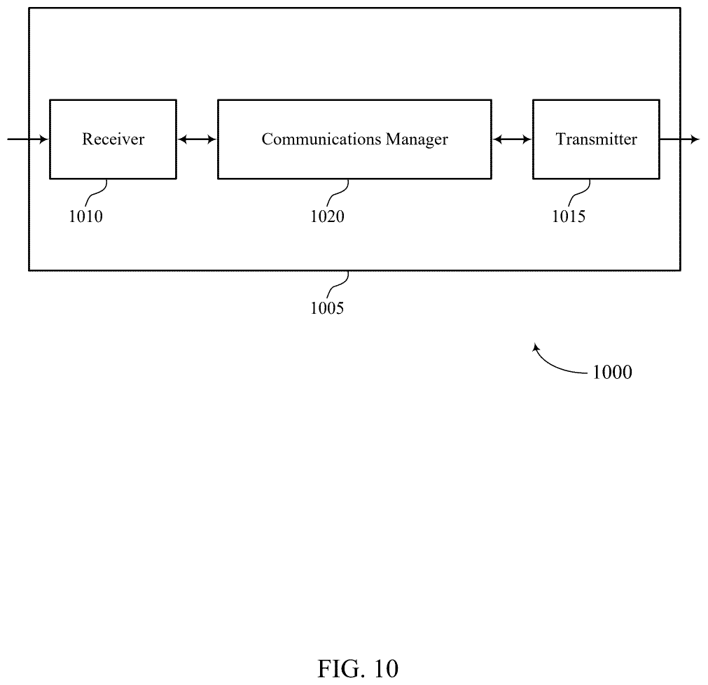

FIG. 10 shows a block diagram 1000 of a device 1005 that supports broadcast and multicast DCI via PDSCH in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some aspects, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some aspects, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of broadcast and multicast DCI via PDSCH as described herein. For example, the communications manager 1020, the receiver 1010, the transmitter 1015, or various combinations or components thereof may be capable of performing one or more of the functions described herein.

In some aspects, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components. The communications manager 1020 is capable of, configured to, or operable to support a means for outputting, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of the set of multiple second network entities, and a respective group of the set of multiple groups, where each group of the set of multiple groups is associated with a different respective MCS.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

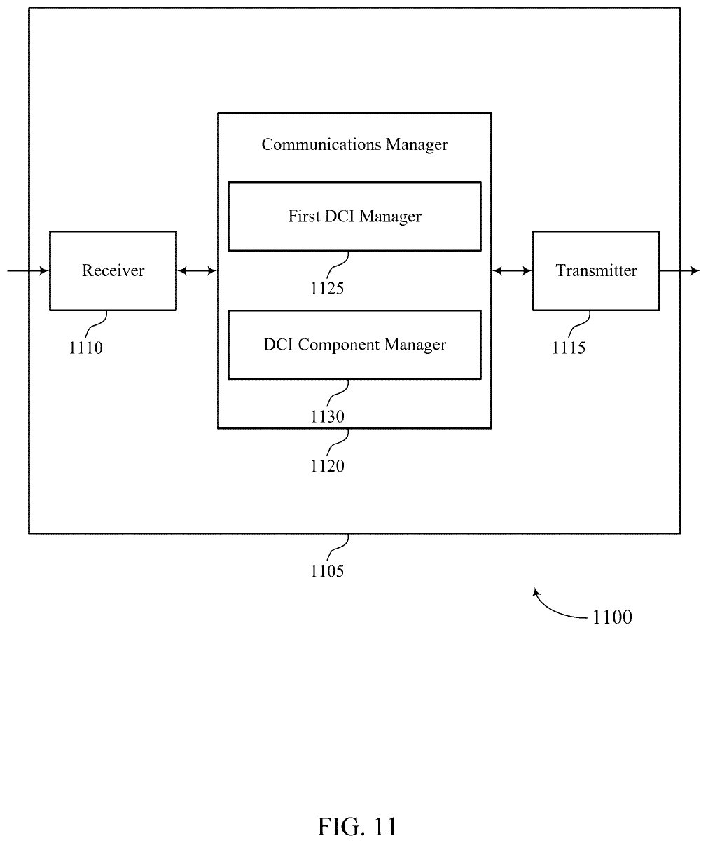

FIG. 11 shows a block diagram 1100 of a device 1105 that supports broadcast and multicast DCI via PDSCH in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some aspects, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some aspects, the transmitter 1115 and the receiver 1110 may be co-located in a transceiver, which may include or be coupled with a modem.

The device 1105, or various components thereof, may be an example of means for performing various aspects of broadcast and multicast DCI via PDSCH as described herein. For example, the communications manager 1120 may include a first DCI manager 1125 a DCI component manager 1130, or any combination thereof. The communications manager 1120 may be an example of aspects of a communications manager 1020 as described herein. In some aspects, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The first DCI manager 1125 is capable of, configured to, or operable to support a means for outputting to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components. The DCI component manager 1130 is capable of, configured to, or operable to support a means for outputting, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of the set of multiple second network entities, and a respective group of the set of multiple groups, where each group of the set of multiple groups is associated with a different respective MCS.

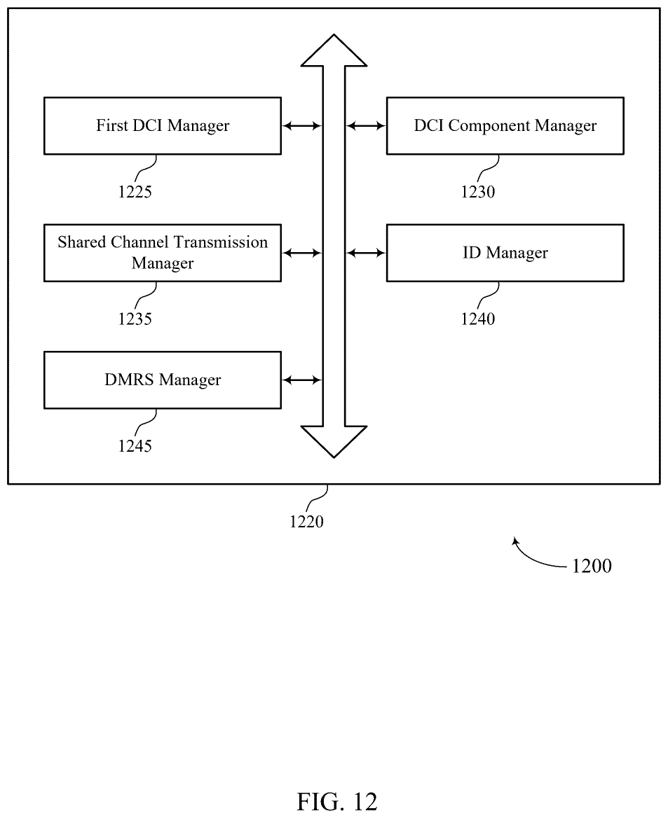

FIG. 12 shows a block diagram 1200 of a communications manager 1220 that supports broadcast and multicast DCI via PDSCH in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of broadcast and multicast DCI via PDSCH as described herein. For example, the communications manager 1220 may include a first DCI manager 1225, a DCI component manager 1230, a shared channel transmission manager 1235, an ID manager 1240, a DMRS manager 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The first DCI manager 1225 is capable of, configured to, or operable to support a means for outputting to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components. The DCI component manager 1230 is capable of, configured to, or operable to support a means for outputting, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of the set of multiple second network entities, and a respective group of the set of multiple groups, where each group of the set of multiple groups is associated with a different respective MCS.

In some aspects, the set of multiple groups includes a first group and a second group. In some aspects, the first group includes a first subset of DCI components of the set of multiple DCI components. In some aspects, the second group includes a second subset of DCI components of the set of multiple DCI components.

In some aspects, the first subset of DCI components includes a first DCI component and a second DCI component. In some aspects, the second subset of DCI components includes a third DCI component. In some aspects, the first DCI component and the second DCI component are encoded with a first MCS. In some aspects, the third DCI component is encoded with a second MCS different than the first MCS.

In some aspects, the second subset of DCI components includes a fourth DCI component. In some aspects, the fourth DCI component is encoded with the second MCS.

In some aspects, a particular group includes a first CRC scrambled by a group identifier associated with the particular group. In some aspects, a particular DCI component within the particular group includes a second CRC scrambled by a device identifier associated with a particular respective second network entity of the set of multiple second network entities.

In some aspects, the ID manager 1240 is capable of, configured to, or operable to support a means for outputting, to the particular respective second network entity, information indicative of the group identifier and the device identifier, where the group identifier and the device identifier are associated with the particular respective second network entity.

In some aspects, the shared channel transmission manager 1235 is capable of, configured to, or operable to support a means for performing a subsequent shared channel transmission in accordance with a particular DCI component of the set of multiple DCI components, where the particular DCI component schedules the subsequent shared channel transmission.

In some aspects, the first DCI indicates one or more of: a quantity of groups of the set of multiple groups; a TDRA of the downlink shared channel transmission; an FDRA of the downlink shared channel transmission; a rank of the downlink shared channel transmission; a respective payload size of each DCI component of the set of multiple DCI components; a respective code rate for each respective group of the set of multiple groups; or a DMRS configuration for the downlink shared channel transmission.

In some aspects, the first DCI includes an indication of a modulation order of the set of multiple groups.

In some aspects, the ID manager 1240 is capable of, configured to, or operable to support a means for outputting an indication of a group identifier associated with the set of multiple second network entities, where the downlink shared channel transmission includes a single DMRS associated with the set of multiple groups, where the single DMRS is scrambled by the group identifier.

In some aspects, at least a portion of the first scheduling information is conveyed via one or more repurposed HARQ fields of the first DCI.

In some aspects, the downlink shared channel transmission includes a header associated with the set of multiple groups.

In some aspects, the header indicates: a quantity of groups of the set of multiple groups; a respective payload size of each DCI component of the set of multiple DCI components; a respective code rate for each respective group of the set of multiple groups; a DMRS configuration for the downlink shared channel transmission; a respective TDRA for each group of the set of multiple groups; or a respective FDRA for each group of the set of multiple groups.

In some aspects, the first DCI includes header information associated with the header.

In some aspects, the header information indicates: a code rate for the header; a TDRA for the header; an FDRA for the header; or a DMRS configuration for the header.

In some aspects, the ID manager 1240 is capable of, configured to, or operable to support a means for outputting an indication of a group identifier associated with the set of multiple second network entities, where the header includes a CRC scrambled by the group identifier.

In some aspects, the DMRS manager 1245 is capable of, configured to, or operable to support a means for outputting, via the downlink shared channel transmission, a single DMRS associated with the set of multiple groups and the header.

In some aspects, the downlink shared channel transmission is a broadcast DCI only PDSCH transmission or a multicast DCI only PDSCH transmission.

In some aspects, the downlink shared channel transmission is a PDSCH transmission.

In some aspects, respective DCI components of each group of the set of multiple groups are encoded as a respective transport block via the different respective MCS.

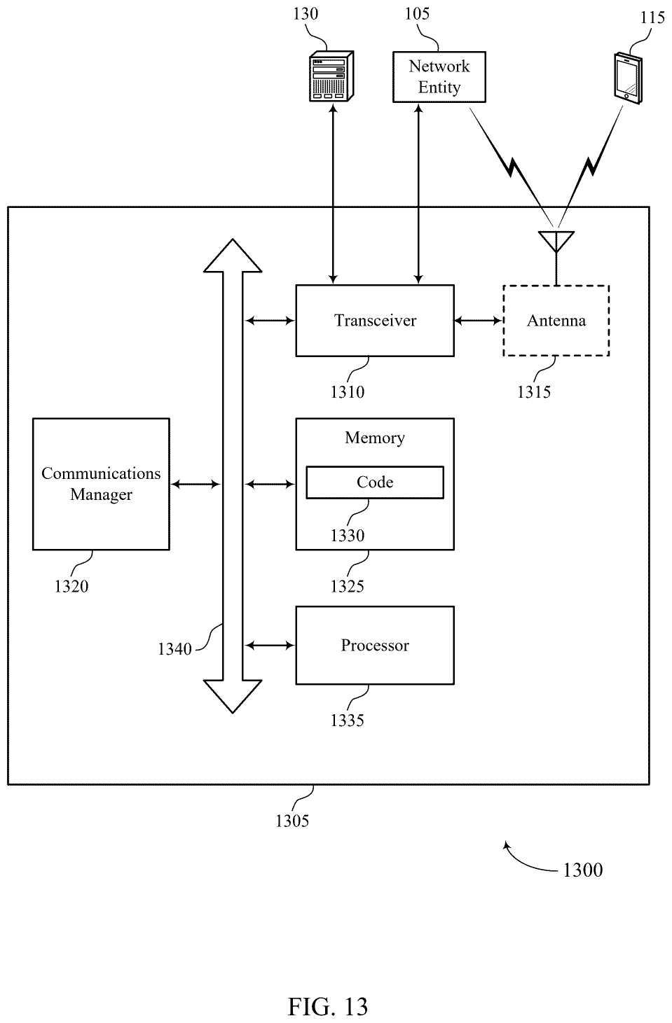

FIG. 13 shows a diagram of a system 1300 including a device 1305 that supports broadcast and multicast DCI via PDSCH in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some aspects, the transceiver 1310 may include a wired transceiver and may communicate bi-directionally with another wired transceiver. Additionally, or alternatively, In some aspects, the transceiver 1310 may include a wireless transceiver and may communicate bi-directionally with another wireless transceiver. In some aspects, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some aspects, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some aspects, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting broadcast and multicast DCI via PDSCH). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some aspects, the at least one processor 1335 may include multiple processors and the at least one memory 1325 may include multiple memories. One or more of the multiple processors may be coupled with one or more of the multiple memories, which may, individually or collectively, be configured to perform various functions herein. In some aspects, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some aspects, a bus 1340 may support communications of (e.g., within) a protocol layer of a protocol stack. In some aspects, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some aspects, the communications manager 1320 may manage aspects of communications with a core network 130 (e.g., via one or more wired or wireless backhaul links). For example, the communications manager 1320 may manage the transfer of data communications for client devices, such as one or more UEs 115. In some aspects, the communications manager 1320 may manage communications with one or more other network entities 105, and may include a controller or scheduler for controlling communications with UEs 115 (e.g., in cooperation with the one or more other network devices). In some aspects, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components. The communications manager 1320 is capable of, configured to, or operable to support a means for outputting, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of the set of multiple second network entities, and a respective group of the set of multiple groups, where each group of the set of multiple groups is associated with a different respective MCS.

By including or configuring the communications manager 1320 in accordance with examples as described herein, the device 1305 may support techniques for improved communication reliability, more efficient utilization of communication resources, and improved coordination between devices.

In some aspects, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, In some aspects, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of broadcast and multicast DCI via PDSCH as described herein, or the at least one processor 1335 and the at least one memory 1325 may be otherwise configured to, individually or collectively, perform or support such operations.

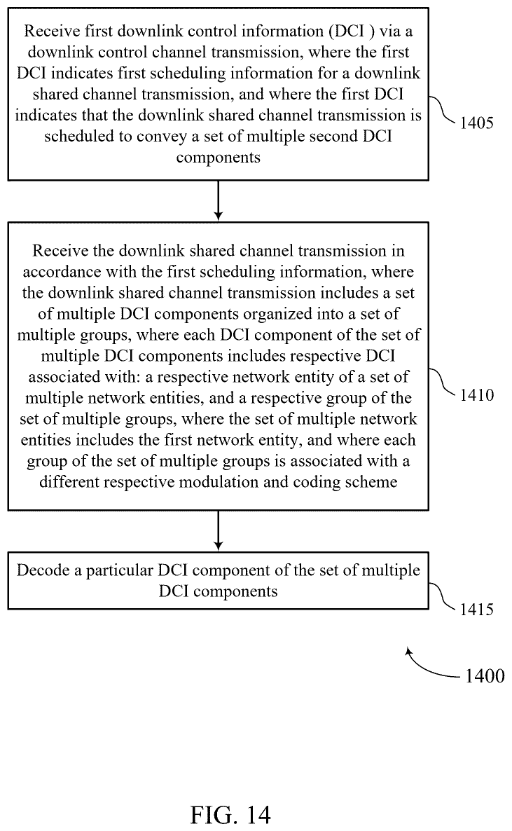

FIG. 14 shows a flowchart illustrating a method 1400 that supports broadcast and multicast DCI via PDSCH in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1405, the method may include receiving first DCI via a downlink control channel transmission, where the first DCI indicates first scheduling information for a downlink shared channel transmission, and where the first DCI indicates that the downlink shared channel transmission is scheduled to convey a set of multiple second DCI components. The operations of 1405 may be performed in accordance with examples as disclosed herein. In some aspects, aspects of the operations of 1405 may be performed by a first DCI manager 825 as described with reference to FIG. 8.

At 1410, the method may include receiving the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective network entity of a set of multiple network entities, and a respective group of the set of multiple groups, where the set of multiple network entities includes the first network entity, and where each group of the set of multiple groups is associated with a different respective MCS. The operations of 1410 may be performed in accordance with examples as disclosed herein. In some aspects, aspects of the operations of 1410 may be performed by a DCI component manager 830 as described with reference to FIG. 8.

At 1415, the method may include decoding a particular DCI component of the set of multiple DCI components. The operations of 1415 may be performed in accordance with examples as disclosed herein. In some aspects, aspects of the operations of 1415 may be performed by a DCI decoding manager 835 as described with reference to FIG. 8.

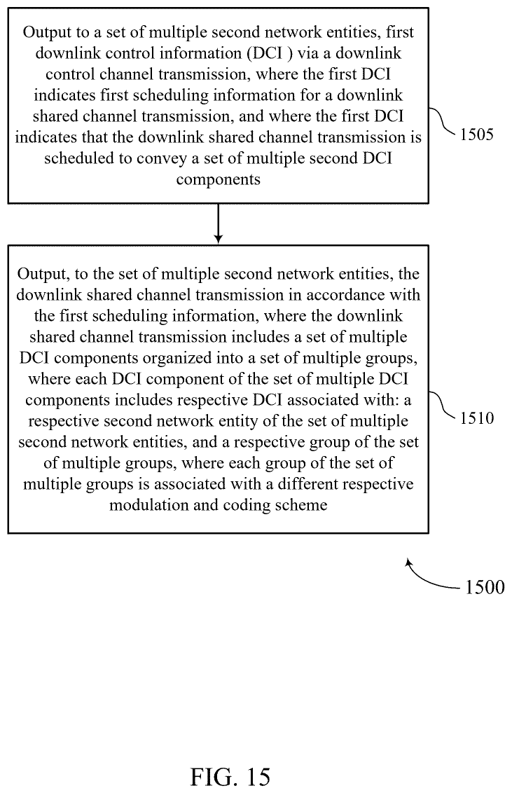

FIG. 15 shows a flowchart illustrating a method 1500 that supports broadcast and multicast DCI via PDSCH in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some aspects, a network entity may execute a set of instructions to control the functional elements of the network entity to perform the described functions. Additionally, or alternatively, the network entity may perform aspects of the described functions using special-purpose hardware.

At 1505, the method may include outputting to a set of multiple second network entities, first DCI via a downlink control channel transmission, where the first DCI indicates first scheduling information for a downlink shared channel transmission, and where the first DCI indicates that the downlink shared channel transmission is scheduled to convey a set of multiple second DCI components. The operations of 1505 may be performed in accordance with examples as disclosed herein. In some aspects, aspects of the operations of 1505 may be performed by a first DCI manager 1225 as described with reference to FIG. 12.

At 1510, the method may include outputting, to the set of multiple second network entities, the downlink shared channel transmission in accordance with the first scheduling information, where the downlink shared channel transmission includes a set of multiple DCI components organized into a set of multiple groups, where each DCI component of the set of multiple DCI components includes respective DCI associated with: a respective second network entity of the set of multiple second network entities, and a respective group of the set of multiple groups, where each group of the set of multiple groups is associated with a different respective MCS. The operations of 1510 may be performed in accordance with examples as disclosed herein. In some aspects, aspects of the operations of 1510 may be performed by a DCI component manager 1230 as described with reference to FIG. 12.

The following provides an overview of aspects of the present disclosure:

Aspect 1: A method of wireless communication performed by a first network entity, comprising: receiving first DCI via a downlink control channel transmission, wherein the first DCI indicates first scheduling information for a downlink shared channel transmission, and wherein the first DCI indicates that the downlink shared channel transmission is scheduled to convey a plurality of second DCI components; receiving the downlink shared channel transmission in accordance with the first scheduling information, wherein the downlink shared channel transmission includes a plurality of DCI components organized into a plurality of groups, wherein each DCI component of the plurality of DCI components includes respective DCI associated with: a respective network entity of a plurality of network entities, and a respective group of the plurality of groups, wherein the plurality of network entities includes the first network entity, and wherein each group of the plurality of groups is associated with a different respective MCS; and decoding a particular DCI component of the plurality of DCI components.

Aspect 2: The method of aspect 1, wherein the plurality of groups includes a first group and a second group, the first group includes a first subset of DCI components of the plurality of DCI components, and the second group includes a second subset of DCI components of the plurality of DCI components.

Aspect 3: The method of aspect 2, wherein the first subset of DCI components includes a first DCI component and a second DCI component, the second subset of DCI components includes a third DCI component, the first DCI component and the second DCI component are encoded with a first MCS, and the third DCI component is encoded with a second MCS different than the first MCS.

Aspect 4: The method of aspect 3, wherein the second subset of DCI components includes a fourth DCI component, and the fourth DCI component is encoded with the second MCS.

Aspect 5: The method of any of aspects 1 through 4, wherein decoding the particular DCI component comprises: determining that a particular group includes a first CRC scrambled by a group identifier, wherein the particular group includes the particular DCI component; and determining that the particular DCI component includes a second CRC scrambled by a device identifier associated with the first network entity.

Aspect 6: The method of aspect 5, further comprising: receiving information indicative of the group identifier and the device identifier, wherein the group identifier and the device identifier are associated with the first network entity.

Aspect 7: The method of any of aspects 1 through 6, wherein decoding the particular DCI component is based on a particular group that includes the particular DCI component including a first CRC scrambled by a group identifier, wherein the particular group includes the particular DCI component; and the particular DCI component including a second CRC scrambled by a device identifier associated with the first network entity.

Aspect 8: The method of any of aspects 1 through 7, further comprising: performing a subsequent shared channel transmission in accordance with the particular DCI component, wherein the particular DCI component schedules the subsequent shared channel transmission.

Aspect 9: The method of any of aspects 1 through 8, wherein the first DCI indicates one or more of a quantity of groups of the plurality of groups; a TDRA of the downlink shared channel transmission; an FDRA of the downlink shared channel transmission; a rank of the downlink shared channel transmission; a respective payload size of each DCI component of the plurality of DCI components; a respective code rate for each respective group of the plurality of groups; or a DMRS configuration for the downlink shared channel transmission.

Aspect 10: The method of any of aspects 1 through 9, wherein the first DCI includes an indication of a modulation order of the plurality of groups.

Aspect 11: The method of any of aspects 1 through 10, further comprising: receiving an indication of a group identifier associated with the plurality of network entities, wherein the downlink shared channel transmission includes a single DMRS associated with the plurality of groups, wherein the single DMRS is scrambled by the group identifier.

Aspect 12: The method of any of aspects 1 through 11, wherein at least a portion of the first scheduling information is conveyed via one or more repurposed HARQ fields of the first DCI.

Aspect 13: The method of any of aspects 1 through 12, wherein the downlink shared channel transmission includes a header associated with the plurality of groups.

Aspect 14: The method of aspect 13, wherein the header indicates one or more of a quantity of groups of the plurality of groups; a respective payload size of each DCI component of the plurality of DCI components; a respective code rate for each respective group of the plurality of groups; a DMRS configuration for the downlink shared channel transmission; a respective TDRA for each group of the plurality of groups; or a respective FDRA for each group of the plurality of groups.

Aspect 15: The method of any of aspects 13 through 14, wherein the first DCI includes header information associated with the header.

Aspect 16: The method of aspect 15, wherein the header information indicates one or more of a code rate for the header; a TDRA for the header; an FDRA for the header; or a DMRS configuration for the header.

Aspect 17: The method of any of aspects 13 through 16, further comprising: receiving an indication of a group identifier associated with the plurality of network entities, wherein the header includes a CRC scrambled by the group identifier.

Aspect 18: The method of any of aspects 13 through 17, further comprising: receiving, via the downlink shared channel transmission, a single DMRS associated with the plurality of groups and the header.

Aspect 19: The method of any of aspects 1 through 18, wherein the downlink shared channel transmission is a broadcast DCI only PDSCH transmission or a multicast DCI only PDSCH transmission.

Aspect 20: The method of any of aspects 1 through 19, wherein the downlink shared channel transmission is a PDSCH transmission.

Aspect 21: The method of any of aspects 1 through 20, wherein respective DCI components of each group of the plurality of groups are encoded as a respective transport block via the different respective MCS.

Aspect 22: A method of wireless communication performed by a first network entity, comprising: outputting to a plurality of second network entities, first DCI via a downlink control channel transmission, wherein the first DCI indicates first scheduling information for a downlink shared channel transmission, and wherein the first DCI indicates that the downlink shared channel transmission is scheduled to convey a plurality of second DCI components each associated with; outputting, to the plurality of second network entities, the downlink shared channel transmission in accordance with the first scheduling information, wherein the downlink shared channel transmission includes a plurality of DCI components organized into a plurality of groups, wherein each DCI component of the plurality of DCI components includes respective DCI associated with: a respective second network entity of a plurality of second network entities, and a respective group of the plurality of groups, wherein each group of the plurality of groups is associated with a different respective MCS.

Aspect 23: The method of aspect 22, wherein the plurality of groups includes a first group and a second group, the first group includes a first subset of DCI components of the plurality of DCI components, and the second group includes a second subset of DCI components of the plurality of DCI components.

Aspect 24: The method of aspect 23, wherein the first subset of DCI components includes a first DCI component and a second DCI component, the second subset of DCI components includes a third DCI component, the first DCI component and the second DCI component are encoded with a first MCS, and the third DCI component is encoded with a second MCS different than the first MCS.

Aspect 25: The method of aspect 24, wherein the second subset of DCI components includes a fourth DCI component, and the fourth DCI component is encoded with the second MCS.

Aspect 26: The method of any of aspects 22 through 25, wherein a particular group includes a first CRC scrambled by a group identifier associated with the particular group, and a particular DCI component within the particular group includes a second CRC scrambled by a device identifier associated with a particular respective second network entity of the plurality of second network entities.

Aspect 27: The method of aspect 26, further comprising: outputting, to the particular respective second network entity, information indicative of the group identifier and the device identifier, wherein the group identifier and the device identifier are associated with the particular respective second network entity.

Aspect 28: The method of any of aspects 22 through 27, further comprising: performing a subsequent shared channel transmission in accordance with a particular DCI component of the plurality of DCI components, wherein the particular DCI component schedules the subsequent shared channel transmission.

Aspect 29: The method of any of aspects 22 through 28, wherein the first DCI indicates one or more of a quantity of groups of the plurality of groups; a TDRA of the downlink shared channel transmission; an FDRA of the downlink shared channel transmission; a rank of the downlink shared channel transmission; a respective payload size of each DCI component of the plurality of DCI components; a respective code rate for each respective group of the plurality of groups; or a DMRS configuration for the downlink shared channel transmission.

Aspect 30: The method of any of aspects 22 through 29, wherein the first DCI includes an indication of a modulation order of the plurality of groups.

Aspect 31: The method of any of aspects 22 through 30, further comprising: outputting an indication of a group identifier associated with the plurality of second network entities, wherein the downlink shared channel transmission includes a single DMRS associated with the plurality of groups, wherein the single DMRS is scrambled by the group identifier.

Aspect 32: The method of any of aspects 22 through 31, wherein at least a portion of the first scheduling information is conveyed via one or more repurposed HARQ fields of the first DCI.

Aspect 33: The method of any of aspects 22 through 32, wherein the downlink shared channel transmission includes a header associated with the plurality of groups.

Aspect 34: The method of aspect 33, wherein the header indicates one or more of a quantity of groups of the plurality of groups; a respective payload size of each DCI component of the plurality of DCI components; a respective code rate for each respective group of the plurality of groups; a DMRS configuration for the downlink shared channel transmission; a respective TDRA for each group of the plurality of groups; or a respective FDRA for each group of the plurality of groups.

Aspect 35: The method of any of aspects 33 through 34, wherein the first DCI includes header information associated with the header.

Aspect 36: The method of aspect 35, wherein the header information indicates one or more of a code rate for the header; a TDRA for the header; an FDRA for the header; or a DMRS configuration for the header.

Aspect 37: The method of any of aspects 33 through 36, further comprising: outputting an indication of a group identifier associated with the plurality of second network entities, wherein the header includes a CRC scrambled by the group identifier.

Aspect 38: The method of any of aspects 33 through 37, further comprising: outputting, via the downlink shared channel transmission, a single DMRS associated with the plurality of groups and the header.

Aspect 39: The method of any of aspects 22 through 38, wherein the downlink shared channel transmission is a broadcast DCI only PDSCH transmission or a multicast DCI only PDSCH transmission.

Aspect 40: The method of any of aspects 22 through 39, wherein the downlink shared channel transmission is a PDSCH transmission.

Aspect 41: The method of any of aspects 22 through 40, wherein respective DCI components of each group of the plurality of groups are encoded as a respective transport block via the different respective MCS.

Aspect 42: A first network entity for wireless communication, comprising a processing system configured to perform a method of any of aspects 1 through 21.

Aspect 43: A first network entity for wireless communications, comprising at least one means for performing a method of any of aspects 1 through 21.

Aspect 44: A non-transitory computer-readable medium having code for wireless communication stored thereon that, when executed by a first network entity, causes the first network entity to perform a method of any of aspects 1 through 21.

Aspect 45: A first network entity for wireless communication, comprising a processing system configured to perform a method of any of aspects 22 through 41.

Aspect 46: A first network entity for wireless communications, comprising at least one means for performing a method of any of aspects 22 through 41.

Aspect 47: A non-transitory computer-readable medium having code for wireless communication stored thereon that, when executed by a first network entity, causes the first network entity to perform a method of any of aspects 22 through 41.

The methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium.

Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B.

Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items).

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
a processing system configured to:
receive first downlink control information (DCI) via a downlink control channel transmission, wherein the first DCI indicates first scheduling information for a downlink shared channel transmission, and wherein the first DCI indicates that the downlink shared channel transmission is scheduled to convey a plurality of second DCI components;
receive the downlink shared channel transmission in accordance with the first scheduling information, wherein the downlink shared channel transmission includes a plurality of DCI components organized into a plurality of groups, wherein each DCI component of the plurality of DCI components includes respective DCI associated with: a respective network entity of a plurality of network entities, and a respective group of the plurality of groups, wherein the plurality of network entities includes the first network entity, and wherein each group of the plurality of groups is associated with a different respective modulation and coding scheme; and
decode a particular DCI component of the plurality of DCI components.

2. The first network entity of claim 1, wherein:
the plurality of groups includes a first group and a second group,
the first group includes a first subset of DCI components of the plurality of DCI components, and
the second group includes a second subset of DCI components of the plurality of DCI components.

3. The first network entity of claim 2, wherein:
the first subset of DCI components includes a first DCI component and a second DCI component,
the second subset of DCI components includes a third DCI component,
the first DCI component and the second DCI component are encoded with a first modulation and coding scheme, and
the third DCI component is encoded with a second modulation and coding scheme different than the first modulation and coding scheme.

4. The first network entity of claim 3, wherein:
the second subset of DCI components includes a fourth DCI component, and
the fourth DCI component is encoded with the second modulation and coding scheme.

5. The first network entity of claim 1, wherein, to decode the particular DCI component, the processing system is configured to:
determine that a particular group includes a first cyclic redundancy check scrambled by a group identifier, wherein the particular group includes the particular DCI component; and
determine that the particular DCI component includes a second cyclic redundancy check scrambled by a device identifier associated with the first network entity.

6. The first network entity of claim 5, wherein the processing system is configured to:
receive information indicative of the group identifier and the device identifier, wherein the group identifier and the device identifier are associated with the first network entity.

7. The first network entity of claim 1, wherein the processing system is configured to decode the particular DCI component based on:
a particular group that includes the particular DCI component including a first cyclic redundancy check scrambled by a group identifier, wherein the particular group includes the particular DCI component, and
the particular DCI component including a second cyclic redundancy check scrambled by a device identifier associated with the first network entity.

8. The first network entity of claim 1, wherein the particular DCI component schedules a subsequent shared channel transmission, wherein the processing system is configured to:
perform the subsequent shared channel transmission in accordance with the particular DCI component.

9. The first network entity of claim 1, wherein the first DCI indicates one or more of:
a quantity of groups of the plurality of groups;
a time domain resource allocation of the downlink shared channel transmission;
a frequency domain resource allocation of the downlink shared channel transmission; a rank of the downlink shared channel transmission;
a respective payload size of each DCI component of the plurality of DCI components;
a respective code rate for each respective group of the plurality of groups; or
a demodulation reference signal configuration for the downlink shared channel transmission.

10. The first network entity of claim 1, wherein the first DCI includes an indication of a modulation order of the plurality of groups.

11. The first network entity of claim 1, wherein the processing system is configured to:
receive an indication of a group identifier associated with the plurality of network entities, wherein the downlink shared channel transmission includes a single demodulation reference signal associated with the plurality of groups, wherein the single demodulation reference signal is scrambled by the group identifier.

12. The first network entity of claim 1, wherein at least a portion of the first scheduling information is conveyed via one or more repurposed hybrid automatic repeat request fields of the first DCI.

13. The first network entity of claim 1, wherein the downlink shared channel transmission includes a header associated with the plurality of groups.

14. The first network entity of claim 13, wherein the header indicates one or more of:
a quantity of groups of the plurality of groups;
a respective payload size of each DCI component of the plurality of DCI components;
a respective code rate for each respective group of the plurality of groups;
a demodulation reference signal configuration for the downlink shared channel transmission;
a respective time domain resource allocation for each group of the plurality of groups; or
a respective frequency domain resource allocation for each group of the plurality of groups.

15. The first network entity of claim 13, wherein the first DCI includes header information associated with the header.

16. The first network entity of claim 15, wherein the header information indicates one or more of:
a code rate for the header;
a time domain resource allocation for the header;
a frequency domain resource allocation for the header; or
a demodulation reference signal configuration for the header.

17. The first network entity of claim 13, wherein the processing system is configured to:
receive an indication of a group identifier associated with the plurality of network entities, wherein the header includes a cyclic redundancy check scrambled by the group identifier.

18. The first network entity of claim 13, wherein the processing system is configured to:
receive, via the downlink shared channel transmission, a single demodulation reference signal associated with the plurality of groups and the header.

19. The first network entity of claim 1, wherein the downlink shared channel transmission is a broadcast DCI only physical downlink shared channel transmission or a multicast DCI only physical downlink shared channel transmission.

20. The first network entity of claim 1, wherein the downlink shared channel transmission is a physical downlink shared channel transmission.

21. The first network entity of claim 1, wherein respective DCI components of each group of the plurality of groups are encoded as a respective transport block via the different respective modulation and coding scheme.

22. A first network entity, comprising:
a processing system configured to:
output to a plurality of second network entities, first downlink control information (DCI) via a downlink control channel transmission, wherein the first DCI indicates first scheduling information for a downlink shared channel transmission, and wherein the first DCI indicates that the downlink shared channel transmission is scheduled to convey a plurality of second DCI components; and
output, to the plurality of second network entities, the downlink shared channel transmission in accordance with the first scheduling information, wherein the downlink shared channel transmission includes a plurality of DCI components organized into a plurality of groups, wherein each DCI component of the plurality of DCI components includes respective DCI associated with: a respective second network entity of the plurality of second network entities, and a respective group of the plurality of groups, wherein each group of the plurality of groups is associated with a different respective modulation and coding scheme.

23. The first network entity of claim 22, wherein:
the plurality of groups includes a first group and a second group,
the first group includes a first subset of DCI components of the plurality of DCI components, and
the second group includes a second subset of DCI components of the plurality of DCI components.

24. The first network entity of claim 23, wherein:
the first subset of DCI components includes a first DCI component and a second DCI component,
the second subset of DCI components includes a third DCI component,
the first DCI component and the second DCI component are encoded with a first modulation and coding scheme, and
the third DCI component is encoded with a second modulation and coding scheme different than the first modulation and coding scheme.

25. The first network entity of claim 24, wherein:
the second subset of DCI components includes a fourth DCI component, and
the fourth DCI component is encoded with the second modulation and coding scheme.

26. The first network entity of claim 22, wherein:
a particular group includes a first cyclic redundancy check scrambled by a group identifier associated with the particular group, and
a particular DCI component within the particular group includes a second cyclic redundancy check scrambled by a device identifier associated with a particular respective second network entity of the plurality of second network entities.

27. The first network entity of claim 26, the processing system is configured to:
output, to the particular respective second network entity, information indicative of the group identifier and the device identifier, wherein the group identifier and the device identifier are associated with the particular respective second network entity.

28. The first network entity of claim 22, the processing system is configured to:
perform a subsequent shared channel transmission in accordance with a particular DCI component of the plurality of DCI components, wherein the particular DCI component schedules the subsequent shared channel transmission.

29. The first network entity of claim 22, wherein the first DCI indicates one or more of:
a quantity of groups of the plurality of groups;
a time domain resource allocation of the downlink shared channel transmission;
a frequency domain resource allocation of the downlink shared channel transmission; a rank of the downlink shared channel transmission;
a respective payload size of each DCI component of the plurality of DCI components;
a respective code rate for each respective group of the plurality of groups; or
a demodulation reference signal configuration for the downlink shared channel transmission.

30. The first network entity of claim 22, wherein the first DCI includes an indication of a modulation order of the plurality of groups.

31. The first network entity of claim 22, the processing system is configured to:
output an indication of a group identifier associated with the plurality of second network entities, wherein the downlink shared channel transmission includes a single demodulation reference signal associated with the plurality of groups, wherein the single demodulation reference signal is scrambled by the group identifier.

32. The first network entity of claim 22, wherein at least a portion of the first scheduling information is conveyed via one or more repurposed hybrid automatic repeat request fields of the first DCI.

33. The first network entity of claim 22, wherein the downlink shared channel transmission includes a header associated with the plurality of groups.

34. The first network entity of claim 33, wherein the header indicates one or more of: a quantity of groups of the plurality of groups;
a respective payload size of each DCI component of the plurality of DCI components;
a respective code rate for each respective group of the plurality of groups;
a demodulation reference signal configuration for the downlink shared channel transmission;
a respective time domain resource allocation for each group of the plurality of groups; or
a respective frequency domain resource allocation for each group of the plurality of groups.

35. The first network entity of claim 33, wherein the first DCI includes header information associated with the header.

36. The first network entity of claim 35, wherein the header information indicates one or more of:
a code rate for the header;
a time domain resource allocation for the header;
a frequency domain resource allocation for the header; or
a demodulation reference signal configuration for the header.

37. The first network entity of claim 33, the processing system is configured to:
output an indication of a group identifier associated with the plurality of second network entities, wherein the header includes a cyclic redundancy check scrambled by the group identifier.

38. The first network entity of claim 33, wherein the processing system is configured to:
output, via the downlink shared channel transmission, a single demodulation reference signal associated with the plurality of groups and the header.

39. The first network entity of claim 22, wherein the downlink shared channel transmission is a broadcast DCI only physical downlink shared channel transmission or a multicast DCI only physical downlink shared channel transmission.

40. The first network entity of claim 22, wherein the downlink shared channel transmission is a physical downlink shared channel transmission.

41. The first network entity of claim 22, wherein respective DCI components of each group of the plurality of groups are encoded as a respective transport block via the different respective modulation and coding scheme.

42. A method of wireless communication performed by a first network entity, comprising:
receiving first downlink control information (DCI) via a downlink control channel transmission, wherein the first DCI indicates first scheduling information for a downlink shared channel transmission, and wherein the first DCI indicates that the downlink shared channel transmission is scheduled to convey a plurality of second DCI components;
receiving the downlink shared channel transmission in accordance with the first scheduling information, wherein the downlink shared channel transmission includes a plurality of DCI components organized into a plurality of groups, wherein each DCI component of the plurality of DCI components includes respective DCI associated with: a respective network entity of a plurality of network entities, and a respective group of the plurality of groups, wherein the plurality of network entities includes the first network entity, and wherein each group of the plurality of groups is associated with a different respective modulation and coding scheme; and
decoding a particular DCI component of the plurality of DCI components.

43. A method of wireless communication performed by a first network entity, comprising:
outputting to a plurality of second network entities, first downlink control information (DCI) via a downlink control channel transmission, wherein the first DCI indicates first scheduling information for a downlink shared channel transmission, and wherein the first DCI indicates that the downlink shared channel transmission is scheduled to convey a plurality of second DCI components; and
outputting, to the plurality of second network entities, the downlink shared channel transmission in accordance with the first scheduling information, wherein the downlink shared channel transmission includes a plurality of DCI components organized into a plurality of groups, wherein each DCI component of the plurality of DCI components includes respective DCI associated with: a respective second network entity of the plurality of second network entities, and a respective group of the plurality of groups, wherein each group of the plurality of groups is associated with a different respective modulation and coding scheme.
